(19) United States
(12) Patent Application Publication
(10) Pub. No.: US 2002/0065707 A1
(43) Pub. Date: May 30, 2002

(54) Automobile customer information generation and transmission system

(75) Inventors: Jon E. Lancaster, Madison, WI (US); Benjamin J. Lancaster, Madison, WI (US); James A. Budinetz, Madison, WI (US)

Correspondence Address: Paul S. Hunter, FOLEY & LARDNER, Firstar Center, 777 East Wisconsin Avenue, Milwaukee, WI, 53202-5367, US

(73) Assignee: Glacier Advertising Ltd.

(21) Appl. No.: 09/726,832

(22) Filed: Nov. 30, 2000

(51) Int. Cl. G06F 17/60

(52) U.S. Cl. 705/10; 705/26

(57) ABSTRACT

A method and system for electronically gathering data about a potential customer of a new or used product are described. In one embodiment, a portion of the consideration the customer may rely on to purchase or lease the new product is a used product. The system may include a data processing module accessible by a manufacturer of the new product, a location for displaying samples of the new product, and an input device located at the location and coupled to the data processing module. The input device is capable of conveying customer data representative of characteristics of the customer to the second data processing system. The customer data is stored in the data processing module and is accessible by the manufacturer. Also discussed is a method of doing business in which a central firm practices the method and system for electronically gathering data.

### BACKGROUND OF THE INVENTION

The present specification relates to the systematic development of information from the end user/purchaser of products. In particular, one embodiment relates to development of information relating to purchasers and users of automobiles, and conveying predefined portions of this information to the automobile manufacturer.

The development of data and generation of information therefrom has become an extremely important tool for the parties involved in all phases of the manufacturing and distribution chain for many products. In particular, in the area of consumer products, consumers are obtaining substantial data and information from the Internet. In many cases this information permits the consumer to make a more informed purchase so that they obtain increased value from the purchase. This increased value may mean the same product for less money, a better product for the same amount of money as a lesser product, the same product for the same amount of money but with better service, a product customized for the user's preferences or needs, volume discounts, and other increased value criteria.

One specific area where consumers have been able to benefit from the availability of information has been automobile purchasing. The Internet has made information available to consumers in a systematic and easily useable form. For example, Internet web sites such as edmunds.com and kbb.com provide consumers with substantial information about automobile features, specifications and pricing. Other sites provide consumers with the ability to purchase cars from the lowest cost seller or a seller willing to sell at a price acceptable to the consumer (e.g. autobytel.com, greenlight.com, carsdirect.com, carmax.com, autonationdirect.com, carorder.com, driveoff.com, etc.). Thus, there is currently a systematic flow of data and information from automobile manufacturers and dealers to consumers, but there is a rather limited systematic flow of data and information from consumers to automobile manufacturers and dealers.

Currently, data about customers is taken at a number of points in such non-orderly fashion that it cannot be systematically accumulated in a way which permits the extraction of substantial amounts of meaningful information for use by automobile manufacturers or a dealers. For example, data is taken from Internet interaction by the customer, by dealers, and by financial institutions. By way of example, types of data taken about the customers generally include information about the financial condition of the customer, trade-in vehicles, type of vehicle desired by the customer, vehicle features desired by the customer, and vehicle features undesirable to the customer. The manners in which the data is recorded vary widely. For example, salespeople may merely listen to customer desires and try to remember what the customer would like until the customer leaves the showroom. Other intake mechanisms may include note pads, sales agreements, lease agreements, loan agreements, or trade-in vehicle and inspection reports. Many of these mechanisms are not electronic and make it difficult to accumulate the data in an effective manner.

In view of the limited systematic availability of customer information available to manufacturers and dealers, it would be desirable to provide a computerized system for providing such availability. Additionally, it would be desirable to make meaningful and complete groupings of information relating to customers readily available.

Furthermore, while informational Internet web sites and vehicle purchase sites exist, no web site or Internet service provides an integrated tool which allows the consumer to gather vehicle information, engage in the vehicle sales process from any location, store vehicle sales information and pause the sales process, and re-engage the sales process from any location. Moreover, conventional systems do not provide for order tracking and post-sale information, such as, vehicle service records and service appointment scheduling. It would be desirable to provide such an integrated tool and system.

### BRIEF SUMMARY OF THE INVENTION

One aspect of a first embodiment relates to a system for electronically gathering data about a potential customer of a new or used product, wherein a portion of the consideration the customer will rely on to purchase or lease the new product is a used product. This system can include a data processing module accessible by a manufacturer of the new product, a location for displaying samples of the new product, and an input device located at the location and coupled to the data processing module. The input device is capable of conveying customer data representative of characteristics of the customer to the data processing module. The customer data is stored in the data processing module and is accessible by the manufacturer.

Briefly, an aspect of a second embodiment relates to a method for electronically gathering data about a potential customer of a new or used product, where a portion of the consideration the customer will rely on to purchase or lease the new product is a used product. This method can include processing data accessible by a manufacturer of the new product, displaying samples of the new product, and conveying customer data representative of characteristics of the customer to a data processing module. The customer data is stored in the data processing module and is accessible by the manufacturer.

Briefly, an aspect of another embodiment relates to a system in which data is electronically gathered about a potential customer of a new or used product. A portion of the consideration to purchase or lease the new product is a used product. This system can include means for processing data accessible by a manufacturer of the new product, means for displaying samples of the new product and means for conveying customer data representative of characteristics of the customer to a data processing module. The customer data is stored in the data processing module and is accessible by the manufacturer.

Briefly, an aspect of another embodiment relates to a system for electronically gathering data about a potential customer of a vehicle. This system can include a first location at which the vehicle is displayed, reviewed, delivered, or sold, a data processing module for storing customer data in association with a customer identification, a first data input module located at the first location for communicating customer data about the customer to the data processing module, and a second data input module located at a location geographically separated from the first location. The customer data is related to one or more automobiles of interest to the customer. The second data input module is configured to communicate with the data processing module via a network to permit access to and modification of the customer data by the customer identified by the customer identification.

Briefly, an aspect of another embodiment relates to a method for electronically gathering data about a potential customer of a vehicle. This method can be associated with displaying, reviewing, delivering, or selling a vehicle; storing customer data in association with a customer identification; communicating vehicle data about the customer to a data processing module; and communicating with the data processing module via a network to permit access to and modification of the customer data by the customer identified by the customer identification. The vehicle data includes at least data about one or more automobiles of interest to the customer.

Briefly, an aspect of another embodiment relates to a system which electronically gathers data about a potential customer of a vehicle. This system can include means for displaying, reviewing, delivering, or selling a vehicle, means for storing customer data in association with a customer identification with a data processing module, means for communicating data about the customer to the data processing module, and means for communicating with the data processing module via a network to permit access to and modification of the customer data by the customer identified by the customer identification. The data includes at least data about one or more automobiles of interest to the customer.

Briefly, an aspect of another embodiment relates to a method of doing business in which a central firm provides technology and information services to at least one recipient comprising at least one original equipment manufacturer (OEM) and at least one OEM dealer/distributor. This method can include receiving at the central firm an expense payment from a recipient of the technology and information services, communicating information among and between a customer and the recipient, and facilitating commercial transactions with the customer.

Other features and advantages of embodiments of the present invention will become apparent to those skilled in the art upon review of the following drawings, the detailed description, and the appended claims.

### BRIEF DESCRIPTION OF THE DRAWINGS

The invention is illustrated by way of example and not limitation in the figures of the accompanying drawings, in which like references indicate similar elements and in which:

FIG. 1 is a general diagrammatical representation of a system for gathering data about a potential customer of a new product and data about used products;

FIG. 2 is a general functional block diagram illustrating information available to a manufacturer in the system illustrated in FIG. 1;

FIG. 3 is a diagram illustrating exemplary functionalities of a sales and appraisal tool included in the system illustrated in FIG. 1;

FIG. 4 is a flow diagram illustrating an exemplary method for electronically gathering information about a customer or a product in the system illustrated in FIG. 1;

FIG. 5 is a diagrammatical representation of a business model to be used with the system illustrated in FIG. 1;

FIG. 6 is a flow diagram illustrating an exemplary method of facilitating commercial transactions in the system illustrated in FIG. 1;

FIG. 7 is a flow diagram illustrating an exemplary method of selecting vehicles and accessories at the location of a distributor near the customer in the system illustrated in FIG. 1;

FIG. 8 is an exemplary screen display illustrating a log in function in the method illustrated in FIG. 7;

FIG. 9 is an exemplary screen display illustrating a vehicle selection function in the method illustrated in FIG. 7;

FIG. 10 is an exemplary screen display illustrating an accessories selection function in the method illustrated in FIG. 7;

FIG. 11 is an exemplary screen display illustrating a dealer location function in the method illustrated in FIG. 7;

FIG. 12 is an exemplary screen display illustrating an inventory match function in the method illustrated in FIG. 7;

FIG. 13 is an exemplary screen display illustrating a dealer showroom function in the method illustrated in FIG. 7;

FIG. 14 is a flow diagram illustrating an exemplary method for purchasing a vehicle from selecting a vehicle to gaining a loan approval in the system illustrated in FIG. 1;

FIG. 15 is an exemplary screen display illustrating a standard feature display function in the method illustrated in FIG. 14;

FIG. 16 is an exemplary screen display illustrating a finance estimator function in the method illustrated in FIG. 14;

FIG. 17 is an exemplary screen display illustrating a credit application function in the method illustrated in FIG. 14;

FIG. 18 is an exemplary screen display illustrating a credit notification function in the method illustrated in FIG. 14;

FIG. 19 is an exemplary screen display illustrating a current information log function in the method illustrated in FIG. 14;

FIG. 20 is an exemplary screen display illustrating a warranty notification function in the method illustrated in FIG. 14;

FIG. 21 is an exemplary screen display illustrating a popup message notification function in the method illustrated in FIG. 14;

FIG. 22 is an exemplary screen display illustrating a lender information log function in the method illustrated in FIG. 14;

FIG. 23 is an exemplary screen display illustrating an order tracking function in the method illustrated in FIG. 14;

FIG. 24 is a flow diagram illustrating an exemplary method of facilitating service arrangements between consumers and service providers in the system illustrated in FIG. 1;

FIG. 25 is an exemplary screen display illustrating a log in function in the method illustrated in FIG. 24;

FIG. 26 is an exemplary screen display illustrating a owner profile function in the method illustrated in FIG. 24;

FIG. 27 is an exemplary screen display illustrating a service history function in the method illustrated in FIG. 24;

FIG. 28 is an exemplary screen display illustrating a service type selection function in the method illustrated in FIG. 24;

FIG. 29 is an exemplary screen display illustrating a scheduling function in the method illustrated in FIG. 24;

FIG. 30 is an exemplary screen display illustrating a weekly scheduling function in the method illustrated in FIG. 24;

FIG. 31 is an exemplary screen display illustrating a second weekly scheduling function in the method illustrated in FIG. 24;

FIG. 32 is an exemplary screen display illustrating a confirmation function in the method illustrated in FIG. 24;

FIG. 33 is an exemplary screen display illustrating a log in for pickup function in the method illustrated in FIG. 24; and

FIG. 34 is an exemplary screen display illustrating a details receipt function in the method illustrated in FIG. 24.

### DETAILED DESCRIPTION OF EXEMPLARY EMBODIMENTS

A system for and a method of electronically gathering data about a potential customer or a product are described. In the following description, for purposes of explanation, numerous specific details are set forth to provide a thorough understanding of exemplary embodiments of the present invention. It will be evident, however, to one skilled in the art that the present invention may be practiced without these specific details. In other instances, well-known structures and devices are shown in block diagram form to facilitate description of the exemplary embodiments of the present invention.

In one embodiment, a computer system is used which has a processing unit that executes sequences of instructions contained in a memory. For example, the computer system can be one or more of a desktop computer, a laptop computer, a server, web access protocol device (WAP), personal digital assistant (PDA), or other computing device. More specifically, execution of the sequences of instructions causes the processing unit to perform steps, which are described below. The instructions may be loaded into a random access memory (RAM) for execution by the processing unit from a read-only memory (ROM), a mass storage device, or some other persistent storage. In other embodiments, hardwired circuitry may be used in place of, or in combination with, software instructions to implement the present invention. Thus, the embodiments described herein are not limited to any specific combination of hardware circuitry and software, nor to any particular source for the instructions executed by the computer system.

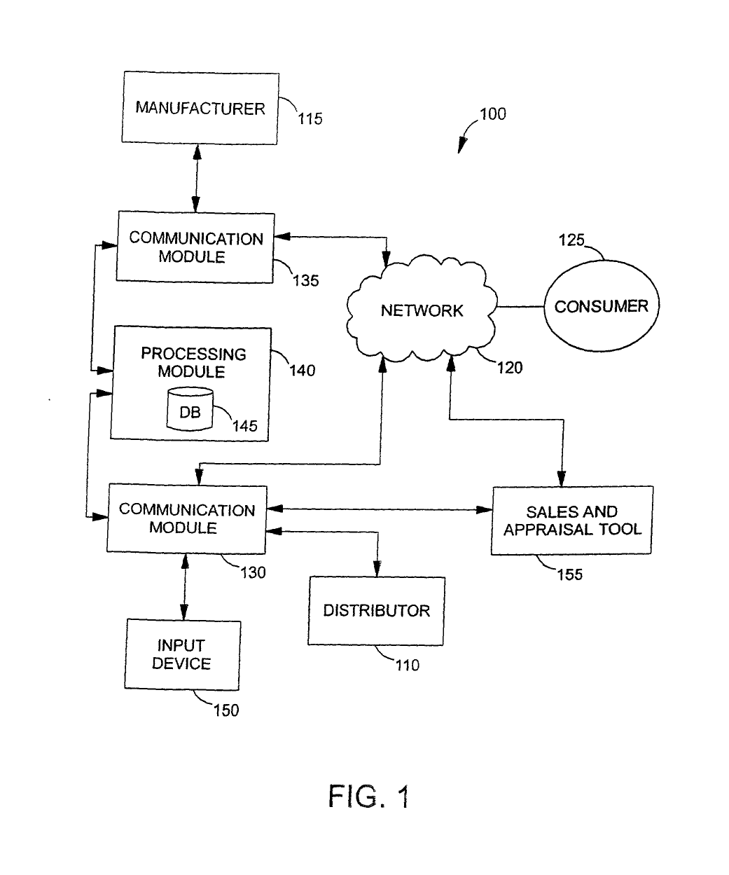

FIG. 1 illustrates a system 100 for electronically gathering data about a potential customer of a new product and data about used products. System 100 includes a distributor 110, a manufacturer 115, and a network 120. Distributor 110 can be a car dealership, a vehicle fulfillment center, a distribution location, a vehicle auction facility, or any other location for the provision or display of new and used products, such as, vehicles. Manufacturer 115 can be a manufacturer of products (e.g., an OEM, such as Ford or General Motors) provided or displayed by distributor 110. Manufacturer 115 can be the entity that creates the product or the entity which sells a product under a brand where the product is manufactured by another.

Network 120 is a communication network of computing devices. In one embodiment, network 120 is the Internet, a worldwide network of computer networks that use TCP/IP network protocols to facilitate data transmission and exchange. In another embodiment, network 120 can be a public or private wide area network. Network 120 provides for communication among distributor 110, manufacturer 115, and a consumer 125 in a variety of ways. A consumer 125, for example, can communicate with network 120 using a personal computer. In one embodiment, consumer 125 communicates using an Internet Service Provider (ISP). In alternative embodiments, consumer 125 communicates with network 120 using a variety of different communication devices, such as, a telephone, a wireless access protocol (WAP) device, personal digital assistant (PDA), or a satellite enabled device.

Distributor 110 communicates with network 120 using a communication module 130. Manufacturer 115 communicates with network 120 using a communication module 135. Communication modules 130 and 135 can be any combination of hardware and software which permits communication with network 120 and/or a processing module 140. Such combinations of communication devices can include a modem and appropriate computer software which allow communication with the Internet. In one embodiment, such combinations can include a router with high speed communication connections to network 120. In one embodiment, distributor 110 and communication module 130 are in the same location and manufacturer 115 and communication module 135 are in the same location. In another embodiment, communication modules 130 and 135 are remote from distributor 110 and manufacturer 115, respectively.

Processing module 140 manages the communication, storage, and retrieval of information to and from distributor 110 and manufacturer 115. Processing module 140 is any combination of hardware and software, including a database 145. In one embodiment, processing module 140 and distributor 110 are in the same location. In another embodiment, processing module 140 is contained in a web server which is physically remote from distributor 110. Processing module 140 can be integrated with communication module 130 or communication module 135 or, alternatively, processing module is remote from both communication modules 130 and 135. Database 145 is any type of memory, centralized or decentralized, electronic or non-electronic, which facilitates storage of data.

Distributor 110 also communicates via communication module 130 using input device 150. Input device 150 can be a display device and keyboard, a hand held input device, or any other device which communicates information. Information can also (or in lieu of) be communicated in a voice to text format or using voice recognition technology. In one embodiment, input device 150 is used to facilitate the fast, accurate, and uniform communication of information on a used product, such as, a used car. An appraiser or employee at distributor 110 or at a vehicle auction enters information requested by input device 150, which is communicated to distributor 110 and/or processing module 140.

Yet further, distributor 110 can communicate via communication module 130 using a sales and appraisal tool 155. Sales and appraisal tool 155 can include a hand held appraisal device (e.g., a PDA), an interactive computer kiosk located at a display room, a web site, or any other computing mechanism or means which allows a customer to obtain information on new and used products as well as appraisal information on used products. In one embodiment, sales and appraisal tool 155 is implemented using a computer located at a car dealer or distributor that allows a customer to get purchase information on cars.

In another embodiment, sales and appraisal tool 155 includes a hand held device, such as, input device 150, which advantageously allows a customer or, alternatively, an employee at distributor 110 to enter highly accurate and standardized information about a used vehicle, allowing an appraisal to be more accurate. Information can be input using a keyboard, a touch screen, voice activation, or any other input means. Furthermore, information from the appraisal can be processed by processing module 140 and stored. As such, distributor 110 and manufacturer 115 can have access to information about vehicle use that conventionally has only been part of industry scuttlebutt or hearsay. For example, a manufacturer can learn that one type of vehicle consistently has one particular defect from reports on the defect returned from multiple appraisals.

Advantageously, system 100 provides interconnectivity between manufacturer 115 and distributor 110. As such, information relevant to the businesses of manufacturer 115 and distributor 110 can be exchanged. Specifically, information regarding customers and products can be more easily shared. With greater information on customers and products, both manufacturer 115 and distributor 110 can respond to customer needs and desires in a more accurate and speedy fashion. Furthermore, customer 125 has the flexibility of using sales and appraisal tool 155 from any location. Customer 125 has the advantage of increased availability of information. Unlike conventional Internet systems, system 100 provides customer 125 with interconnectivity to manufacturer 115 and distributor 110 with the capability of information extraction, trade-in appraisal, financing approval, and other actions which conventionally are location specific.

The term automobile or car as used herein refers to a new or used truck, sports utility vehicle, van, mini-van, sedan, coupe, sports car, motorcycle or any other road or off-road traveling vehicle. Furthermore, while exemplary embodiments are described with reference to vehicles, such as, automobiles, alternative arrangements are also intended to include boats, jet skis, snowmobiles, construction equipment, farm equipment, etc.

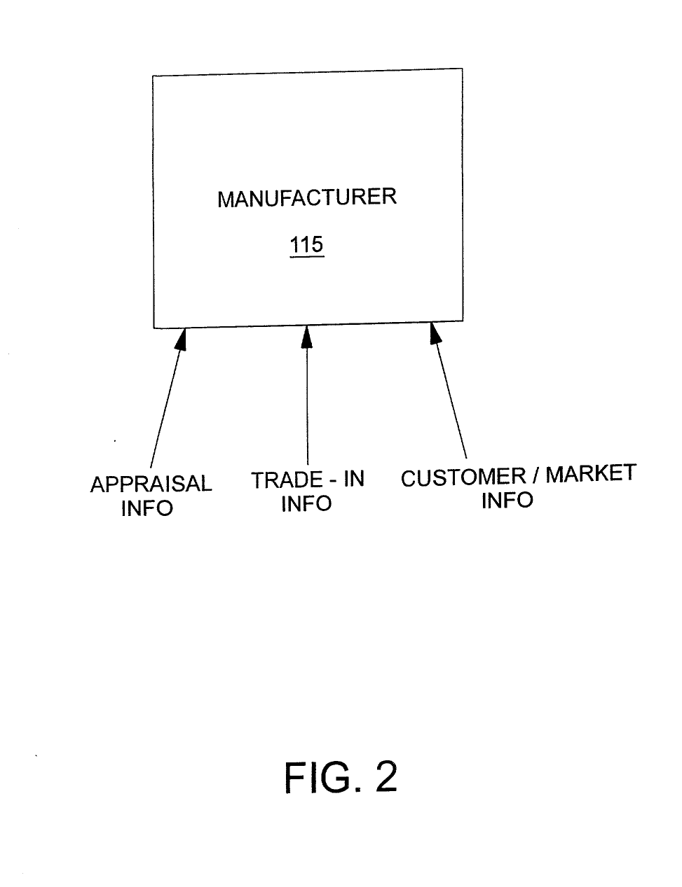

FIG. 2 is a diagrammatical representation of the information available to manufacturer 115 from processing module 140 in one embodiment. In an exemplary embodiment, manufacturer 115 can obtain information taken during an appraisal of a used product, mileage of the used product (or other useage data) data on trade-in factors and terms, and information on customers. For example, manufacturer 115 can access information on what amount was offered in return for a trade-in of a used vehicle but that was unacceptable for the owner and potential customer. Further, manufacturer 115 can obtain information on the customers that are looking for, leasing, financing, or buying certain vehicles. Advantageously, manufacturer 115 can quickly identify whether a target market is being reached. For example, if manufacturer 115 wants to sell a particular car to people that would buy mid-range cars (e.g., Honda Accords), it would be important to know that the particular car is actually attracting people that look at economic cars (e.g., Honda Civics).

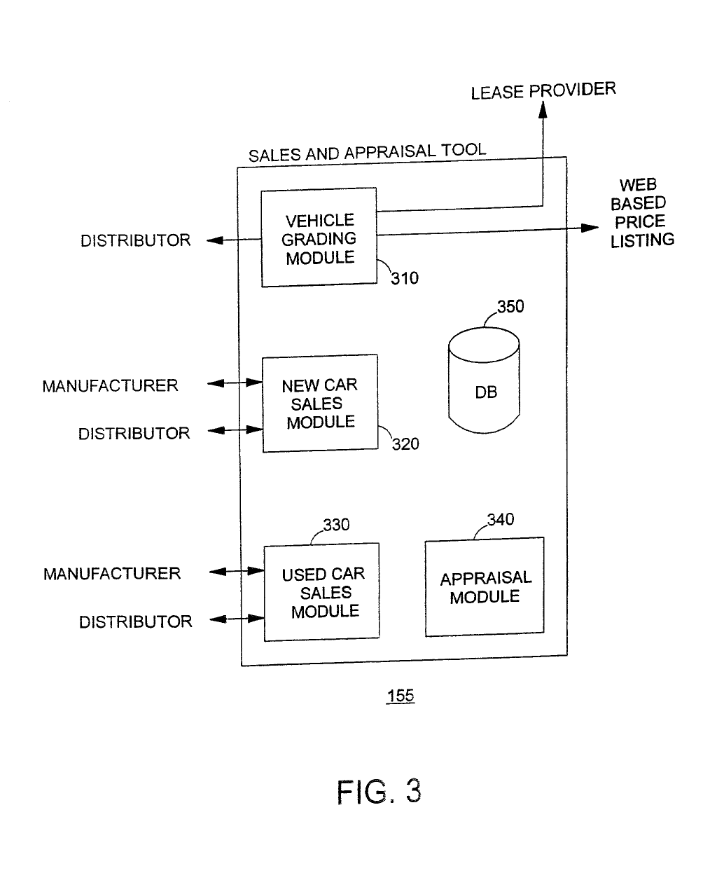

FIG. 3 is a diagram illustrating an exemplary functionality of sales and appraisal tool 155. In one embodiment, sales and appraisal tool 155 includes a vehicle grading module 310, a new car sales module 320, a used car module 330, an appraisal module 340, and a database 350. In alternative embodiments, additional modules or fewer modules are included, depending on the functionalities implemented. Modules 310, 320, 330, and 340 can be implemented in software, hardware, or any combination of software and hardware.

Vehicle grading module 310 provides a grading system for products, such as, vehicles. In one embodiment, vehicle grading module 310 is directed to an auction environment in which valuation of vehicles occurs which are being auctioned. Conventional automobile valuation systems, such as, the Kelly Blue Book take average auction sale prices to determine values of automobiles. The leasing industry also bases valuation on average auction sale prices. Unfortunately, average auction sale prices do not include a grading of the quality of the car, which is a significant factor in the sales price of the car. Advantageously, vehicle grading module 310 includes the ability to grade a vehicle based on a variety of factors, such as, body condition, interior condition, engine condition, and window condition. Factors can differ, depending on the type of vehicle. A rating (e.g., 1-5) or grade (e.g., A, B+, A−) can be assigned to each factor. In one embodiment, the grading includes qualitative descriptions, such as, “scratched paint”, “bent fender”, or any other description. Vehicle grading module 310 can also include or be coupled to databases which include other information related to the vehicle, such as, title, mileage, history, warranty, and other associated information.

Advantageously, the grading system of vehicle grading module 310 provides a better understanding of the auction sale price which can then be used in the valuation of other vehicles. Such grading information is desired by distributors, manufacturers, leasing providers, and information providers because it improves the quality of information they have and identifies potential product defects which can be accounted for in new product designs. In another embodiment, grading and pricing information is provided to the public or selected members of the public (e.g., subscribers) on an Internet web site. Vehicle grading module 310 can be implemented in an auction, a car dealership, on the Internet, or any other platforms or environments.

New car sales module 320 provides an interactive guide to a variety of new vehicles. In one embodiment, new car sales module 320 presents user selectable video and audio clips to discuss features and characteristics of various vehicles. In another embodiment, new car sales module 320 allows the customer to engage in the sales process at the location of distributor 110 or at a different location, pause the sales process at any time, and re-engage in the sales process at the location of distributor 110 or at a different location. Advantageously, new car sales module 320 provides a standard and accurate explanation of vehicle features, a training mechanism for salespersons, and a convenient way for customers to learn about vehicles without visiting a showroom or talking with a live salesperson. Further, new car sales module 320 provides the flexibility of engaging in the sales process at any location. Even further, new car sales module 320 saves information on the sale without completion of the sale.

Used car sales module 330 provides an interactive guide to used vehicles. Functionally, used car sales module 330 includes operations similar to those done by new car sales module 330, such as, presenting selectable video and audio clips to discuss features and characteristics of the vehicle as well as allowing the customer to engage in the sales process at the location of distributor 110 or at a different location, pause the sales process at any time, and re-engage in the sales process at the location of distributor 110 or at a different location. In one embodiment, used car sales module 330 provides a picture of a particular used car being sold. In another embodiment, used car sales module 330 includes grading information on used vehicles.

Appraisal module 340 provides for the appraising of the value of a used product, such as, a used car. Appraisal module 340 can be implemented as interactive computer software on a personal computer (PC), a personal digital assistant (PDA), or any communication interface. In one embodiment, appraisal module 340 includes various interface screens which prompt a user, such as, an employee of distributor 110 for information about the item to be appraised. Alternatively, appraisal module 340 receives input from a voice activation system. Information communication via appraisal module 340 can include customer information, product history information, and other data associated with the determining of the value of the used item. In one embodiment, appraisal module 340 downloads information from computing devices or memory components on the item. Where the item is a vehicle, appraisal module 340 can retrieve information from a plurality of microprocessors and memory devices in the vehicle.

Advantageously, appraisal module 340 permits a customer to get an appraisal to the value of a used vehicle without taking the vehicle to distributor 110. As such, a customer can check the value of his vehicle or a used car that a third party (e.g., a neighbor of the customer) is selling. Further, appraisal module 340 has the advantage of compiling information on actual trade-ins as well as aborted trade-ins, allowing feedback on vehicle use and customer behavior missing in conventional systems. Advantageously, appraisal module 340 provides manufacturer 115 and distributor 110 with data on what appraisals result in trade-ins, what appraisals compare to data collected on vehicles, and other information useable by manufacturer 115 or distributor 110. Advantageously, appraisal module 340 interacts with other modules in sales and appraisal tool 155 to gather customer and vehicle information. Such information can be stored in database 350 and/or database 145 (FIG. 1).

Database 350 provides for the storing of information, such as, customer financial condition, trade-in vehicle information, type of vehicle desired, vehicle features desired, and vehicle features not desired. Database 350 can store a wide variety of information which can also be stored in database 145 (FIG. 1) such that sales and appraisal tool 155 operates faster.

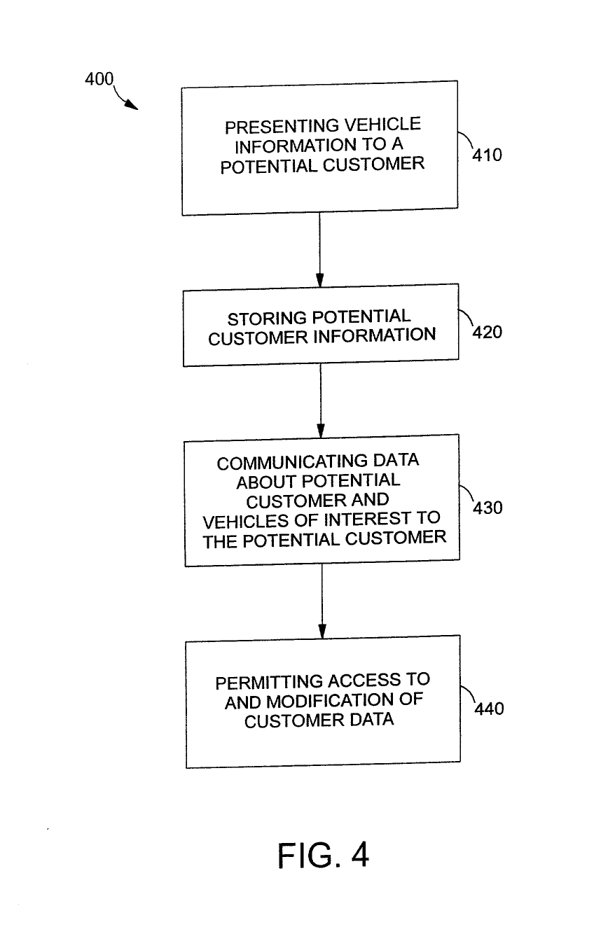

FIG. 4 illustrates a flow diagram 400 of exemplary steps in a method of electronically gathering data about a potential customer of a vehicle. In a step 410, vehicle information is presented to a potential customer. Presentation of such vehicle information can include displaying, reviewing, delivering, locating, customizing, or selling a vehicle. Presentation can be by sales and appraisal tool 155 (FIG. 3) located at distributor 110 or accessed via network 120 from a remote location. In an exemplary embodiment, presentation of vehicle information includes interactive computer software with multimedia capabilities.

After step 410 (or during step 410), a step 420 is performed in which information on a potential customer is obtained. Potential customer information can be acquired overtly by asking questions of the potential customer or passively by tracking potential customer selections and choices. In a step 430, data about the potential customer and vehicles of interest and/or preferences of vehicle features are communicated. Such data can be communicated via sales and appraisal tool 155 and stored in database 145. Examples of customer data include types of previous cars owned, income level, size of family, or other historical and demographic type of information. Examples of vehicle data include historical information on servicing, accidents, performance, and other relevant data.

In a step 440, manufacturer 115 and/or distributor 110 are permitted to access and modify customer and vehicle data. Access and modification can be via a computer interface. In one embodiment, access to such data is controlled by conventionally known security means, such as, firewalls. Continuous access and modification of this data provides advantages, such as, the distributor having current information on the customer and the customer having current information from either the manufacturer or the distributor. Service histories on vehicles can also be compiled and monitored.

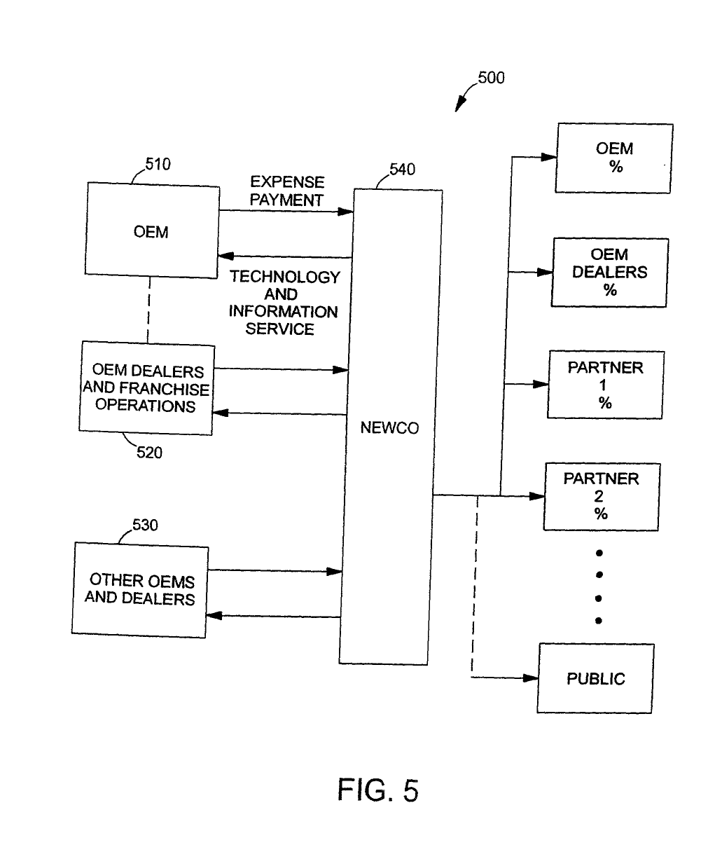

FIG. 5 is a diagrammatical representation of an exemplary embodiment of a business model 500 to be used with system 100. Business model 500 includes blocks representing an Original Equipment Manufacturer (OEM) 510, OEM dealers and franchise operations (OEM dealers) 520, other OEMs and dealers (other OEMs) 530, and a new company (Newco) 540. In an exemplary embodiment, OEM 510, OEM dealers 520, and other OEMs 530 provide expense payments to Newco 540 in exchange for technology and information services.

In an exemplary embodiment, Newco 540 provides technology and information services including a consumer software package component, a vertical technology component, and a new vehicle retail sales component. The consumer software package component informationally unites the customer, dealer, and OEM. In one embodiment, the consumer software package component includes customer interactive sales and touch point gathering software, Internet connectivity, Internet portal, customer relations management software, a central database, and an information analysis and distribution software. The vertical technology component is designed to encompass a “keys to keys” spectrum from the supply channel production to receipt by the retail consumer and to “value capture” a fundamental market change in the structure of producing, selling and purchasing vehicles for the benefit of the OEM, dealer, and the retail consumer. The new vehicle retail sales component includes an e-commerce based new vehicle retail sales model focused on consumer-centric sales/ownership experience with the fulfillment through OEM dealers 520.

In an exemplary embodiment, Newco 540 provides system 100 which communicatively connects distributor 110 and manufacturer 115. Newco 540 can also provide sales and appraisal tool 155 (FIG. 2). In one embodiment, Newco 540 practices the method described with reference to flow diagram 400 in FIG. 4. Advantageously, system 100, sales and appraisal tool 155, and the method associated with flow diagram 400 can provide an automobile customer information generation and transmission system. Increased information availability in such a system benefits distributor 110, manufacturer 115, and consumer 125. Vehicle and consumer information is more current and accurate. Further, the information is directly associated with actual new and used vehicles.

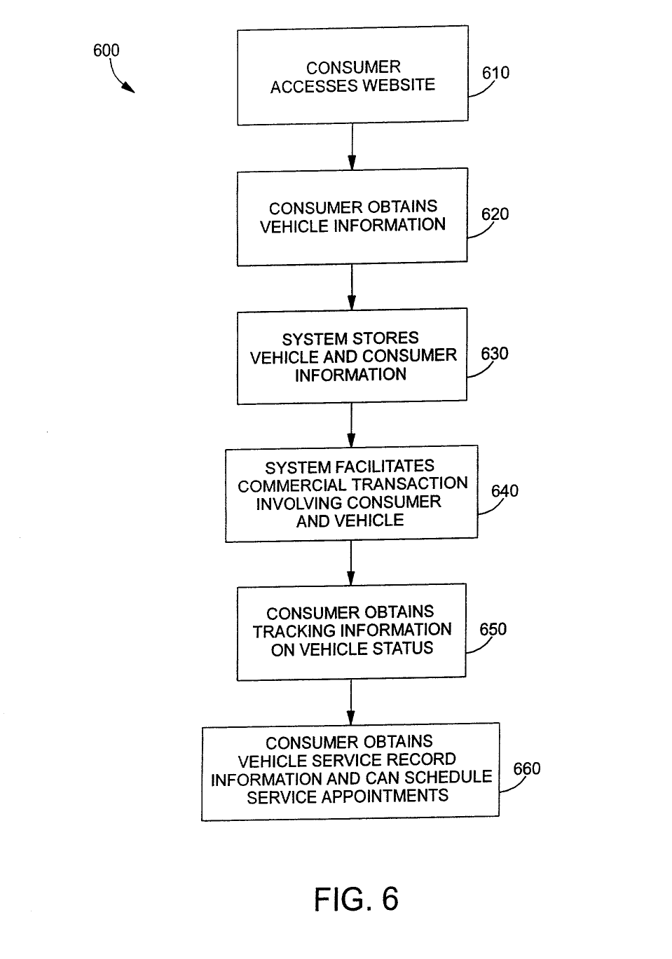

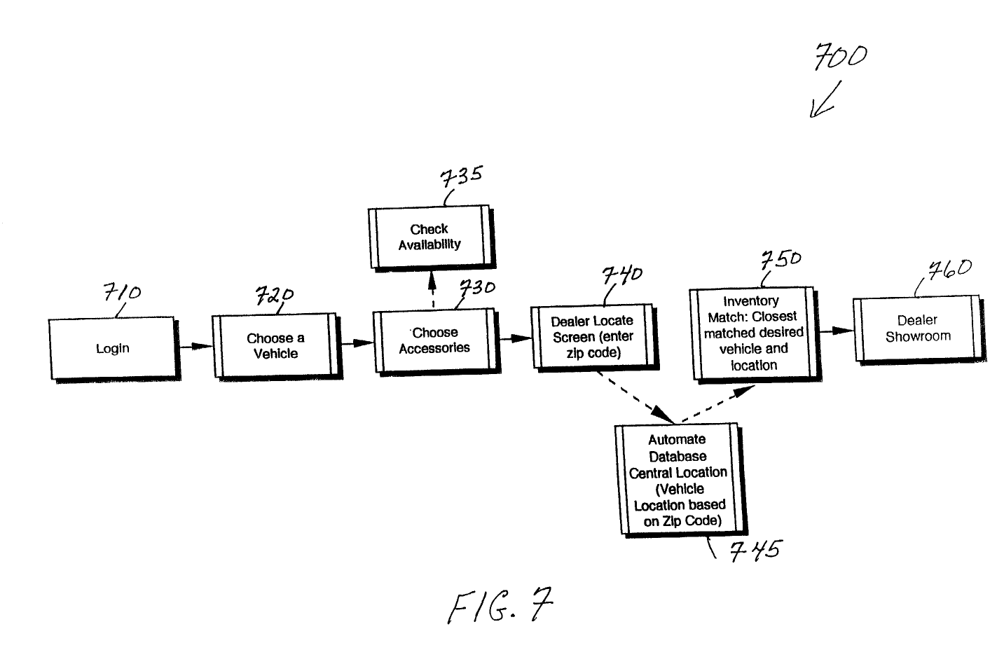

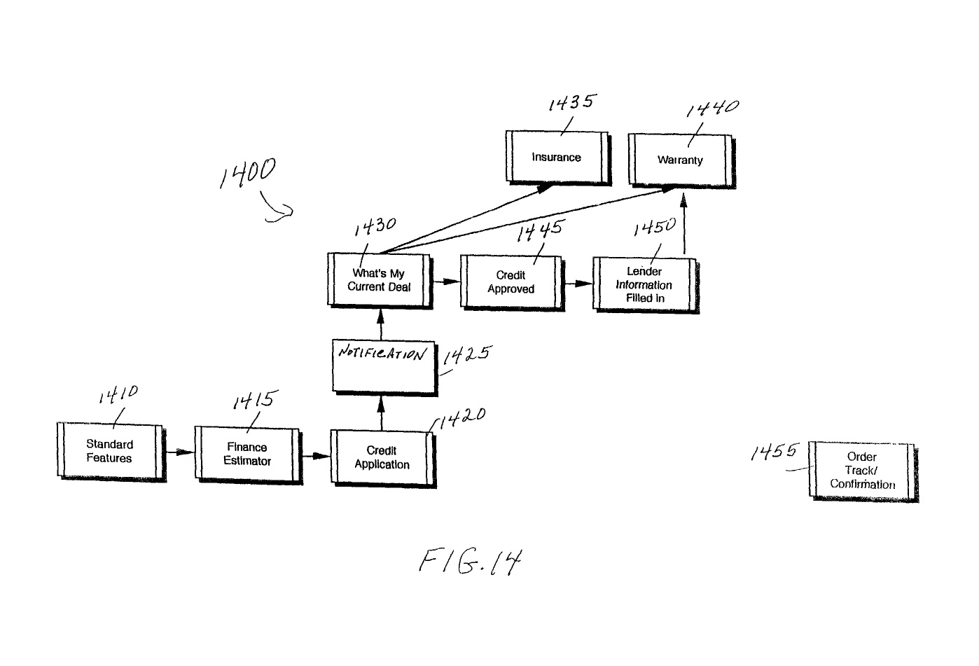

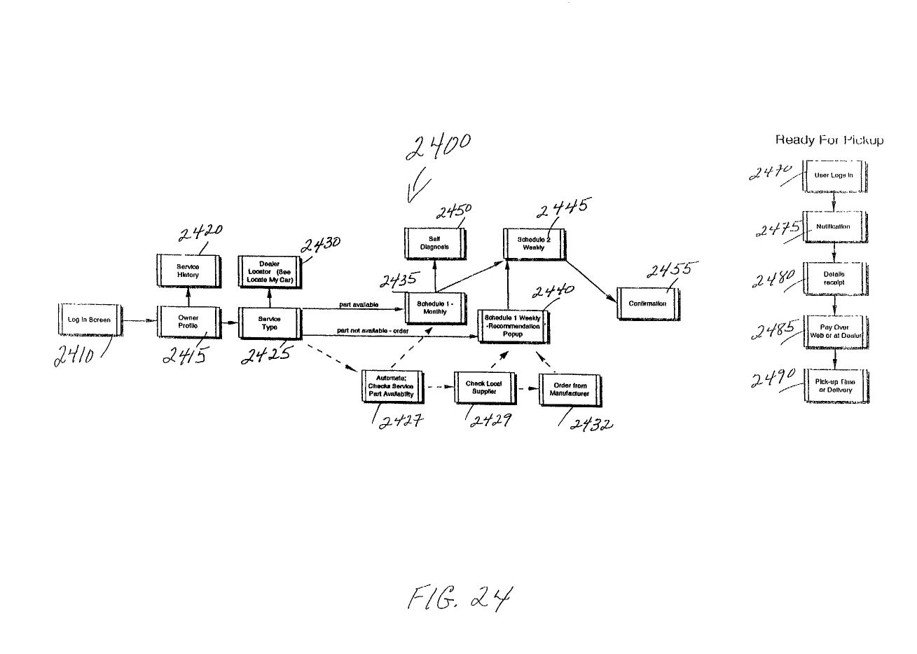

In an exemplary embodiment, Newco 540 practices the method described with reference to flow diagram 600 in FIG. 6. Further, Newco 540 can practice the methods described with reference to flow diagram 700 in FIG. 7, flow diagram 1400 in FIG. 14, or flow diagram 2400 in FIG. 24.

Business model 500 also provides that Newco 540 pays a percentage of return on investment (ROI) to OEM, OEM dealers, and other partners of Newco 540. In an exemplary embodiment, where an initial public offering (IPO) has occurred, the investing public will also receive a percentage ROI from Newco 540.

FIG. 6 illustrates a flow diagram 600 of exemplary steps in a method for facilitating commercial transactions in system 100. In a step 610, a consumer accesses a web site. In one embodiment, a consumer accesses the web site using a personal computer which connects to the Internet via a internet service provider (ISP). In an alternative embodiment, the consumer accesses the web site using a WAP enabled telephone or a similar communication device. After step 610, a step 620 is performed in which the consumer obtains vehicle information from the web site. In one embodiment, the consumer can access vehicle information of vehicles manufactured by a plurality of different originally equipment manufactures (OEMs). In another embodiment, a consumer is able to access vehicle information for used vehicles.

After step 620 (or during step 620), a step 630 is performed in which a web server of a web site system stores vehicle and consumer information. In one embodiment, the web server which runs the computer programs to provide the web site stores information in a database. In another embodiment, a web server communicates vehicle and consumer information to a remote location, where the information is then stored. Examples of the type of information stored may include consumer names or addresses as well as trade-in vehicle data and date of vehicles viewed by the consumer. As such, information may be compiled to create a specific consumer profile or the information may be compiled in an aggregated form to extract trends and other market data associated with consumer activity.

A step 640 is performed in which the system associated with the web site facilitates commercial transactions involving the consumer and vehicles. In one embodiment, such commercial transactions involve only providing comparative information regarding vehicle options and purchase, lease, or financing conditions. In another embodiment, commercial transactions involve engaging in the sales, lease, or financing transaction. Such engagement may involve the completion of a credit application or the completion of other sales documents. In yet another embodiment, the commercial transactions involve the engaging, processing, and completion of vehicle purchases, leases, or financing. Commercial transactions may have specific legal definitions outside the scope of this patent, however, it is the intention for the scope of this patent commercial transaction be as broad as defined herein.

In a step 650, the consumer is able to obtain tracking information on vehicle status after a purchase, lease, or financing transaction has occurred. In one embodiment, the consumer may track steps in the commercial transaction process as well. Advantageously, tracking information on vehicle status allows a consumer to know of the availability, location, and condition of a particular vehicle. In one embodiment, the system is configured to communicate, for example, by electronic mail tracking information directly to the consumer.

In a step 660, the consumer is able to use the web site to obtain vehicle service record information. For example, information on tune-ups and vehicle repair can be provided, including date of repair, service performed, warranty information, and other relevant information. Also, using the web site, the consumer is capable of scheduling service appointments directly with a service center. As such, the consumer can quickly identify available service appointments and schedule the same via the Internet. In an alternative embodiment, services provided by the web site described with reference to FIG. 6 can include on-line vehicle diagnostics.

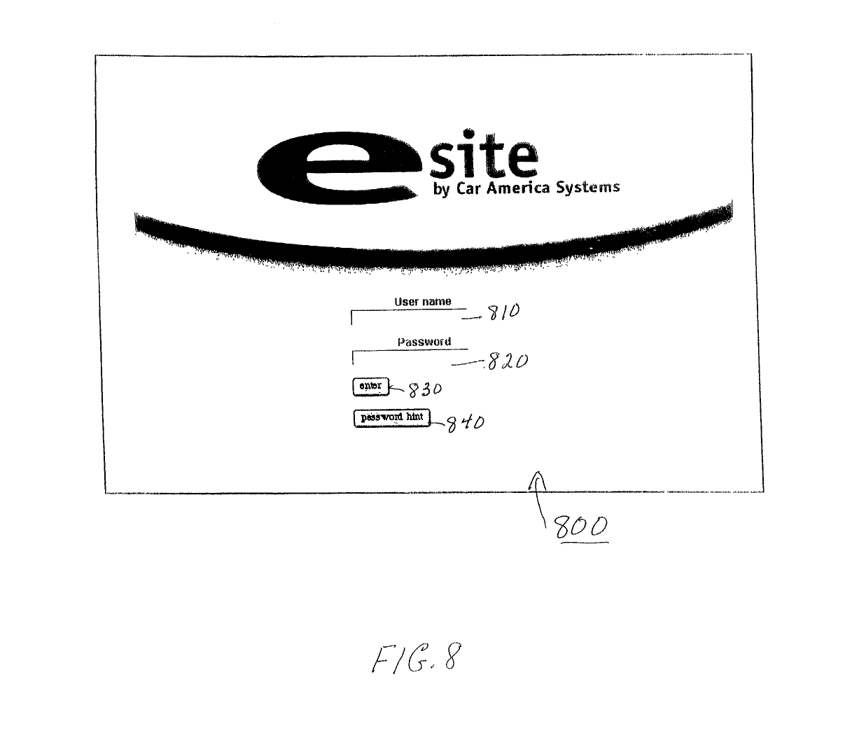

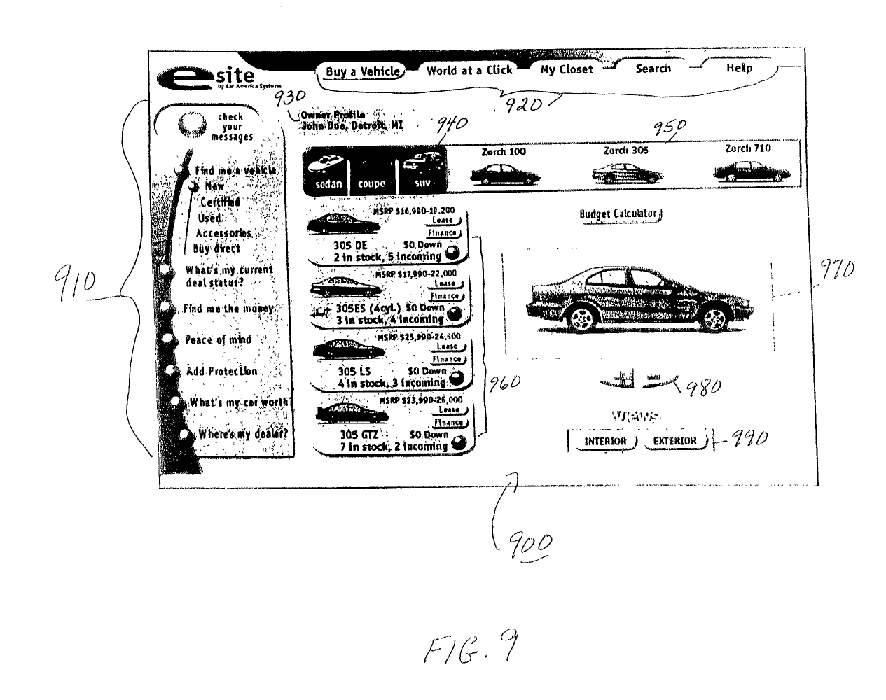

FIG. 7 illustrates a flow diagram 700 of exemplary steps in a method of the selection of vehicles and accessories and the location of a distributor near the customer in system 100. In a step 710, a log-in procedure is performed in which a consumer gains access to information regarding the selection of vehicles and accessories and a location of a distributor near the consumer. In an exemplary embodiment, the consumer enters a user name and password as described with reference to FIG. 8. After step 710, a step 720 is performed in which the consumer selects a vehicle. In an exemplary embodiment, the consumer selects from a menu in a graphical user interface including text and images which facilitate the choice of the consumer. One example of such a graphical user interface is described below with reference to FIG. 9.

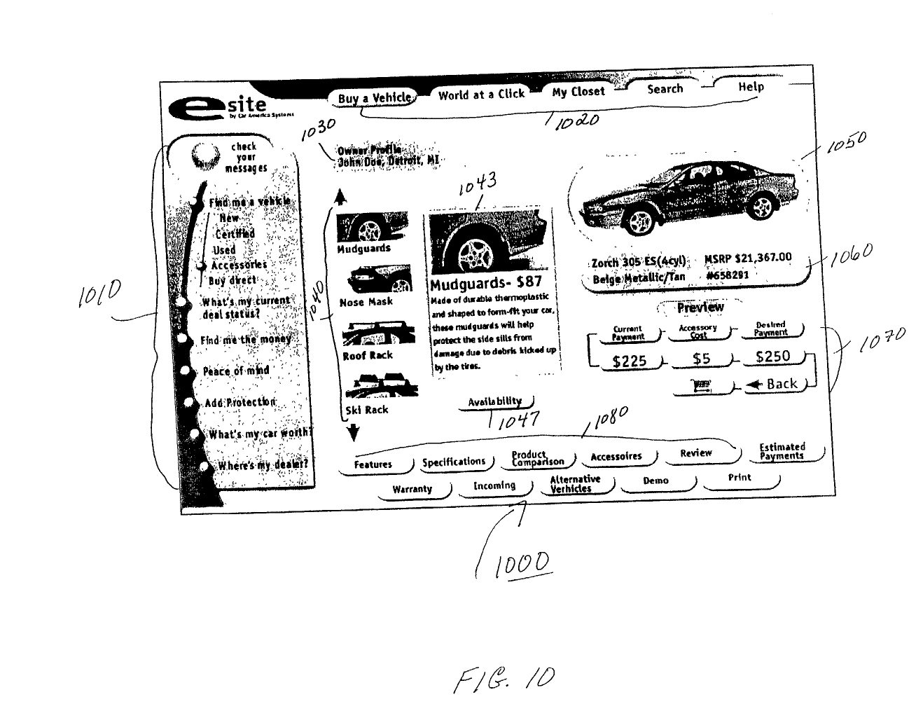

After step 720 is performed, a step 730 is performed in which the consumer can choose accessories from a selection of accessories. In one embodiment, possible accessory selections are provided using a graphical user interface including text and images. One example of such a graphical user interface is described below with reference to FIG. 10. A step 735 can be performed to check the availability of accessories or vehicles selected by the consumer. After selections are made in step 720 and step 730, a step 740 is performed in which a dealer location function is carried out. In an exemplary embodiment, the consumer enters a zip code and the system returns a map and directions to the closest dealer.

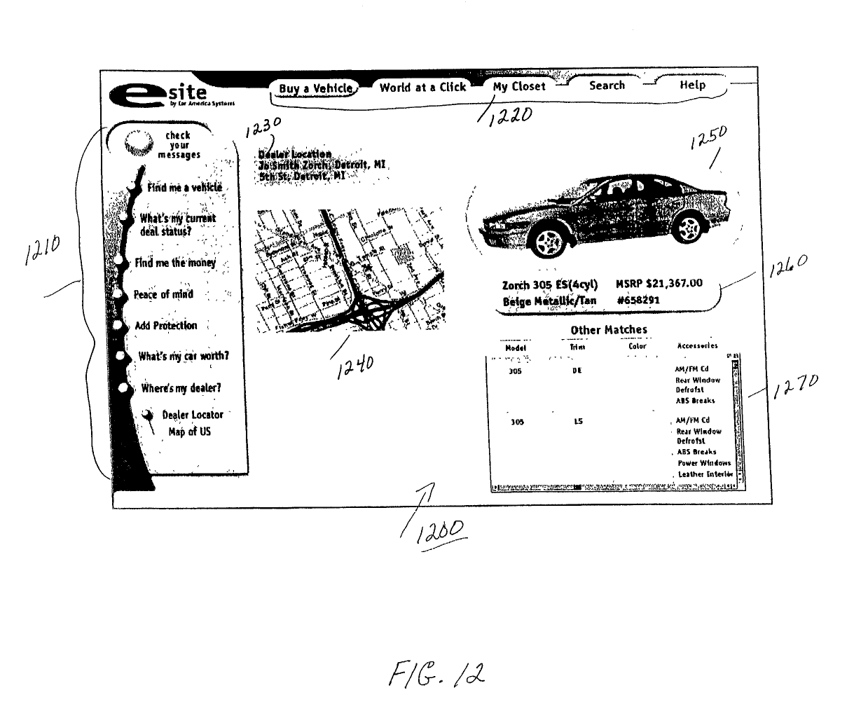

After step 740, a step 745 is performed in which a database is automatically checked to determine the closest location to the zip code entered in step 740 which includes the vehicle selected in step 720. After step 745, a step 750 is performed in which an inventory match function is carried out. In an exemplary embodiment, the inventory match provides the closest match for the desired vehicle selected in step 720 and the location based on the entered zip code located in step 740. A graphical user interface can be provided including text and images with vehicle information, accessory information, and dealer location information. One example of such a graphical user interface is described with reference to FIG. 12. After step 750, a step 760 is performed in which a dealer showroom function is carried out. In an exemplary embodiment, the dealer showroom function allows the consumer to view the specific vehicle of the dealer selected by the consumer.

FIG. 8 illustrates an exemplary screen display 800 of a log-in function in the exemplary method described with reference to FIG. 7. Display 100 includes a user name field box 810, a password field box 820, an enter button 830, and a password hint button 840. User name field box 810 provides a location for a consumer to type a user name to enter into the system. Password field box 820 provides a location where the consumer can enter a password associated with the user name entered in user name field box 810. Once the user name and password are entered, the consumer can submit them by clicking on enter button 830 using a graphical arrow controlled by a mouse or by pressing the enter key on the computer keyboard. If the consumer desires a hint for the password, the consumer may click on password hint button 840 to provide some type of prompt to help remember the password. A variety of alternative procedures are also possible in the implementation of the log-in function.

FIG. 9 illustrates an exemplary screen display 900 of a vehicle selection function in the exemplary method described with reference to FIG. 7. Display 900 includes a menu selection region 910, a function tab set 920, an owner profile region 930, a vehicle type selection menu region 940, a vehicle model selection menu 950, a set of specific vehicle information displays 960, a larger image display 970, operational buttons 980, and view selection buttons 990. In one embodiment, menu 910 allows consumer to check messages directed to the consumer about vehicle availability, service operation, and other such messages. Menu 910 also allows the consumer to jump to a new screen display with different information and operations available. Function tab set 920 provides the consumer with the opportunity to select among various operations, such as, buying a vehicle, searching the web site, getting help, and other such operations available on system 100. Region 930 displays the consumer's name and location, such as, city and state.

Vehicle type selection menu region 940 allows the consumer to select from types of vehicles, such as, sedans, coupes, and sport utility vehicles (SUV). Vehicle model selection menu 950 allows specific selections of vehicle models after a selection of vehicle type is made from menu 940. Displays 960 provide more detailed information on the selected vehicle model and type, such as, manufacturer suggested retail price (MSRP), vehicles in stock, vehicles incoming, and other such vehicle information. Display 970 provides a larger image of the selected vehicle for easier viewing. Buttons 980 allow for quick rotation and manipulation of image displayed in region 970. View selection buttons 990 allow the consumer to select between the interior and exterior of a car. Screen display 900 advantageously allows the consumer to explore various vehicle options to help make an educated purchase. As discussed above, the consumer can view screen display 900 at home, work, a dealership, or any location configured to communicate with system 100.

FIG. 10 illustrates an exemplary screen display 1000 of an accessories selection function in the exemplary method of FIG. 7. Screen display 1000 includes a menu 1010, a function tab set 1020, a owner profile region 1030, an accessory menu 1040, a specific accessory display 1043, an availability button 1047, an image display 1050, a vehicle information display 1060, a cost and payment display 1070, and functional buttons 1080. Menu 1010, function tab set 1020, and owner profile region 1030 are similar in appearance and functionality to menu 910, function tab set 920, and owner profile region 930 described with reference to FIG. 9. Accessory menu 1040 provides images and text to allow the consumer to select from a plurality of different accessories available for the selected vehicle. Display 1043 provides detailed information on the specific accessory selected from accessory menu 1040. Availability button 1047 allows the consumer to request information on the availability of the accessory selected in menu 1040.

Display 1050 provides a larger view of the selected vehicle including the accessory selected from menu 1040. Display 1060 provides information on the particular vehicle, such as, vehicle color, model name, and MSRP. Region 1070 provides information on payment and cost for the selected vehicle. Such information may include a current payment, an accessory cost, and a desired payment. Buttons 1080 allow the consumer to request a variety of additional information, such as, features, specifications, product comparison, accessories, review, estimated payments, warranty, incoming availability, alternative vehicles, demo, and a printing function of screen display 1000. Screen display 1000 allows the customer to explore any accessories which may be of interest in purchasing the vehicle.

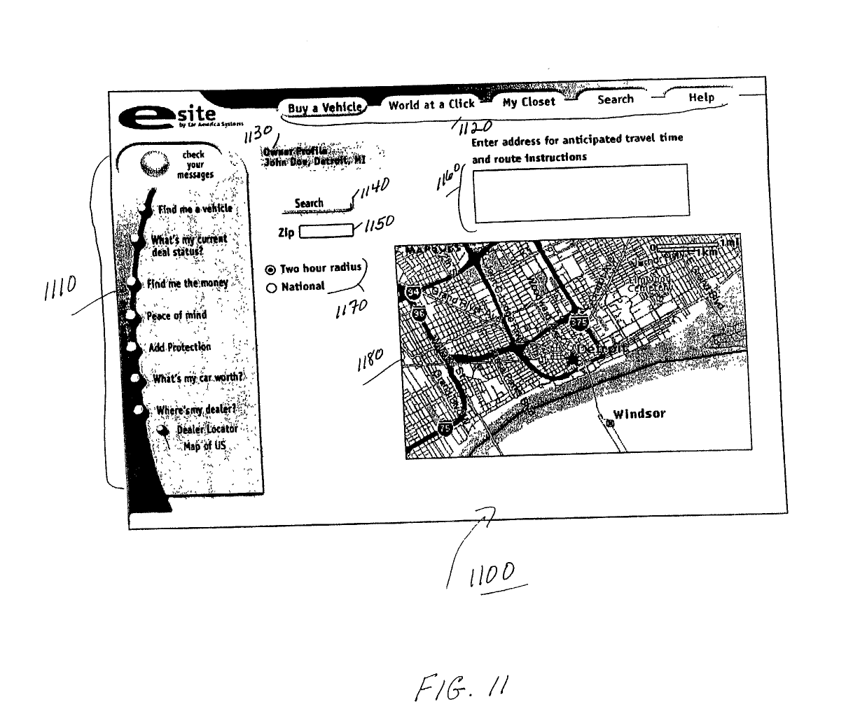

FIG. 11 illustrates an exemplary screen display 1100 of a dealer location function in the exemplary method described with reference to FIG. 7. Screen display 1100 includes a menu 1110, function tab set 1120, owner profile region 1130, a search button 1140, a zip code text field 1150, an address text field 1160, map type selection buttons 1170, and a map display 1180. Menu 1110, function tab set 1120, and owner profile region 1130 are similar to menu 910, function tab set 920, and owner profile region 930 described with reference to FIG. 9. Search button 1140 is selected after a zip code is entered by the consumer into zip code field text field 1150. Entering a zip code allows the consumer to view a map showing dealer locations either within a two hour radius or on a national map as selected in selection buttons 1170. The consumer can enter an address in text field 1160 in order to get an anticipated travel time and route instructions. Advantageously, screen display 1100 allows the consumer to perform a search to locate the desired vehicle based on proximity.

FIG. 12 illustrates an exemplary screen display 1200 of an inventory match function in the exemplary method described with reference to FIG. 7. Screen display 1200 includes a menu 1210, function tab set 1220, dealer location region 1230, map display 1240, image region 1250, vehicle information display 1260, and other matches table 1270. Menu 1210, function tab set 1220, and dealer location region 1230 are similar to menu 910, function tab set 920, and owner profile region 930 described with reference to FIG. 9. Map display 1240 provides a map with a star or other such indicia to indicate location of the vehicle dealer. Image display 1250 provides a graphical image of the selected vehicle including accessories. Vehicle information display 1260 provides text information on the selected vehicle. Other matches table 1270 provides information on vehicles similar to the selected vehicle. Other matches table 1270 can include information, such as, model, trim, color, and accessories. Advantageously, screen display 1200 provides the consumer with a list of all dealers within the searched area and displays a list of matching vehicle criteria. A map to the dealership and directions can also be displayed.

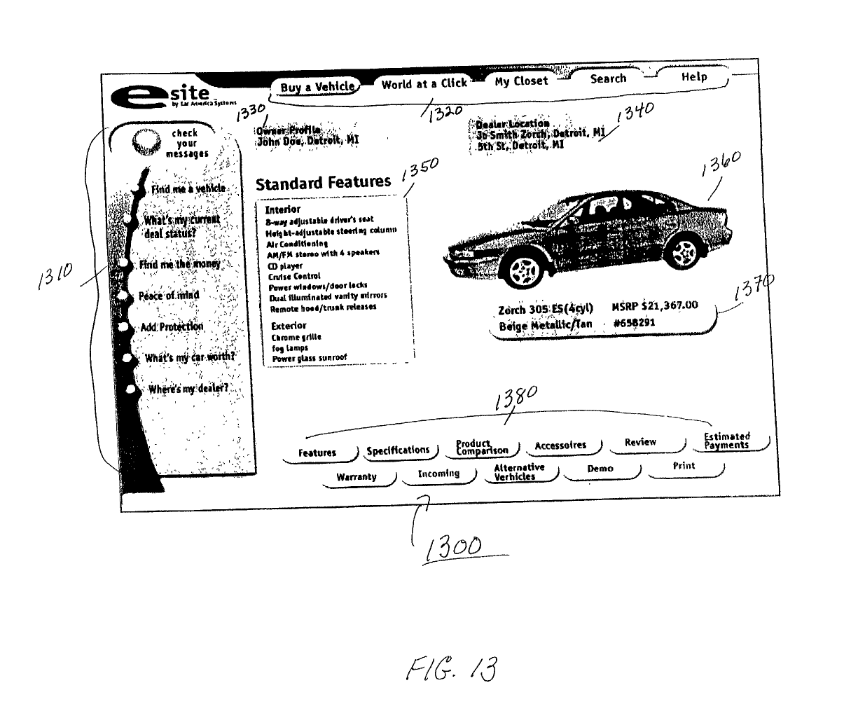

FIG. 13 illustrates an exemplary screen display 1300 of a dealer showroom function in the exemplary method described with reference to FIG. 7. Screen display 1300 includes a menu 1310, function tab set 1320, owner profile region 1330, dealer location region 1340, standard features list 1350, image display 1360, vehicle description display 1370, and buttons 1380. Menu 1310, function tab set 1320, owner profile region 1330, and dealer location region 1340 are similar to menu 910, function tab set 920, and owner profile region 930 described with reference to FIG. 9. Standard features list 1350 provides a brief listing of features including the interior and exterior of the selected vehicle. Image display 1360, vehicle information display 1370, and buttons 1380 are similar in functionality to image display 1050, vehicle information display 1060, and buttons 1080 described with reference to FIG. 10. Screen display 1300 allows the consumer to view dealer specific vehicle information within the context of system 100.

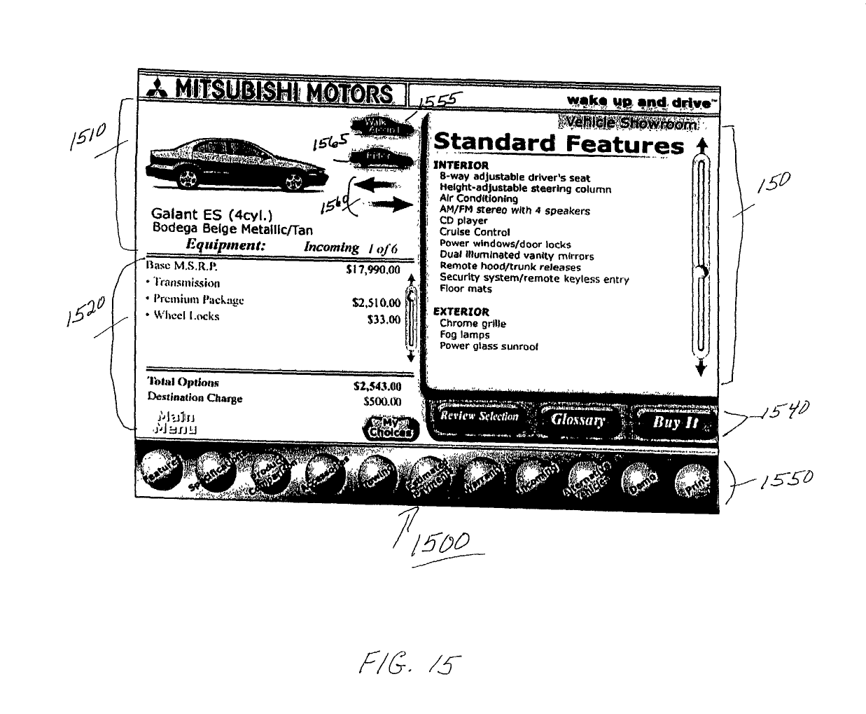

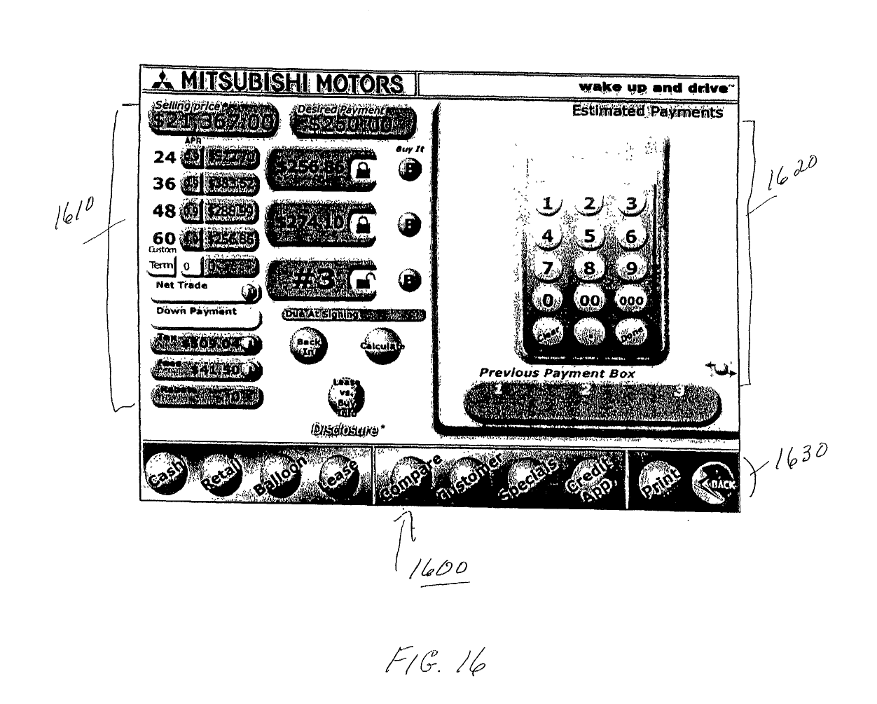

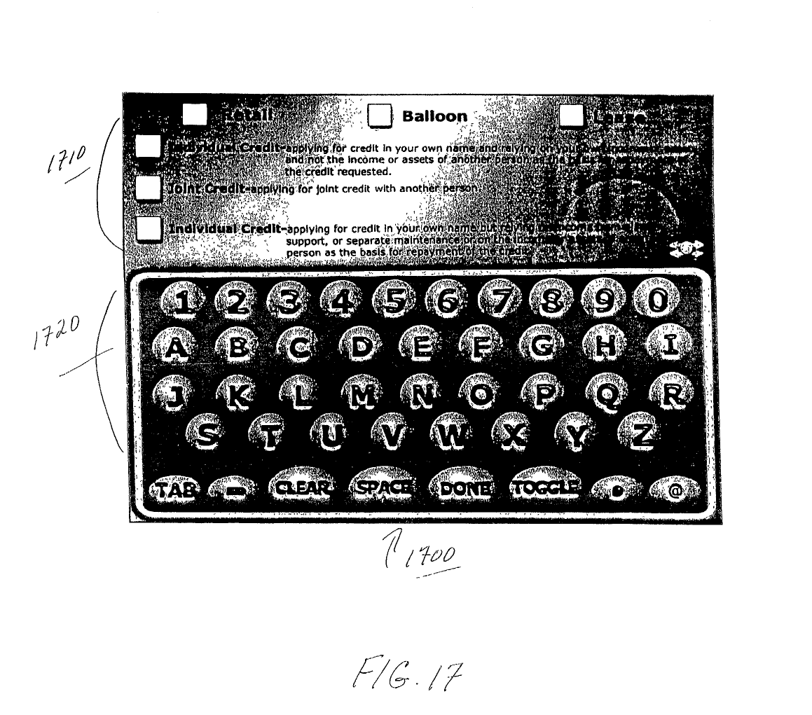

FIG. 14 illustrates a flow diagram 1400 of exemplary steps in a method for purchasing a vehicle from selecting a vehicle to gaining a loan approval in system 100. This method can be utilized for purchasing other products. Vehicles are used here by way of illustration only. Furthermore, other services can be offered to potential customers (e.g., AAA, credit services). In a step 1410, the consumer is provided information on standard features of a selected vehicle. In an exemplary embodiment, a graphical user interface is displayed such as the graphical user interface described with reference to FIG. 15. After step 1410, a step 1415 is performed in which a graphical user interface is displayed to the consumer to provide finance estimating functions. In an exemplary embodiment, the graphical user interface may include the images, text, and functionality described with reference to FIG. 16. After step 1415 is performed, a step 1420 is performed in which a credit application function is provided. In an exemplary embodiment, the credit application function includes a graphical user interface such as the graphical user interface described with reference to FIG. 17.

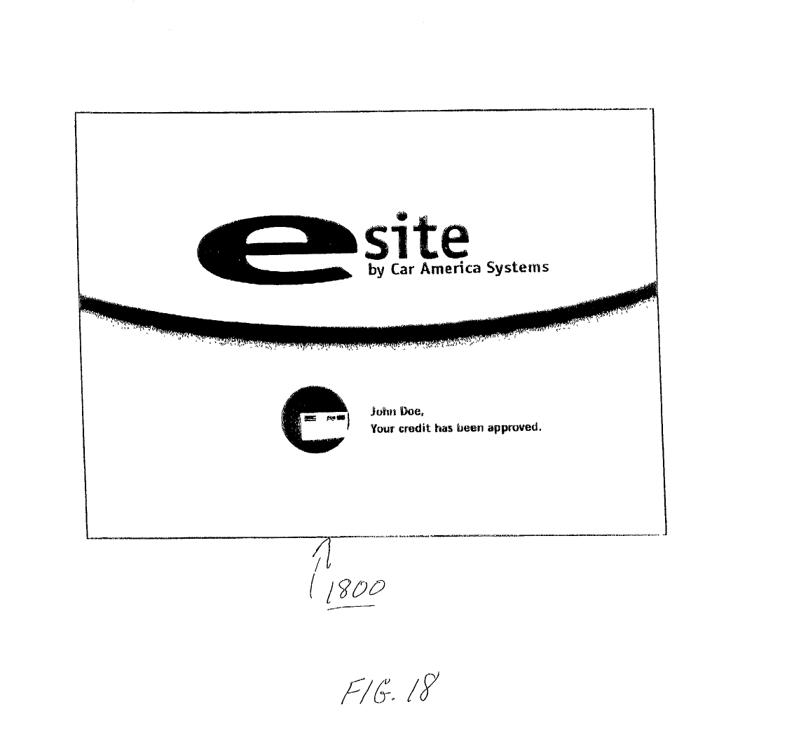

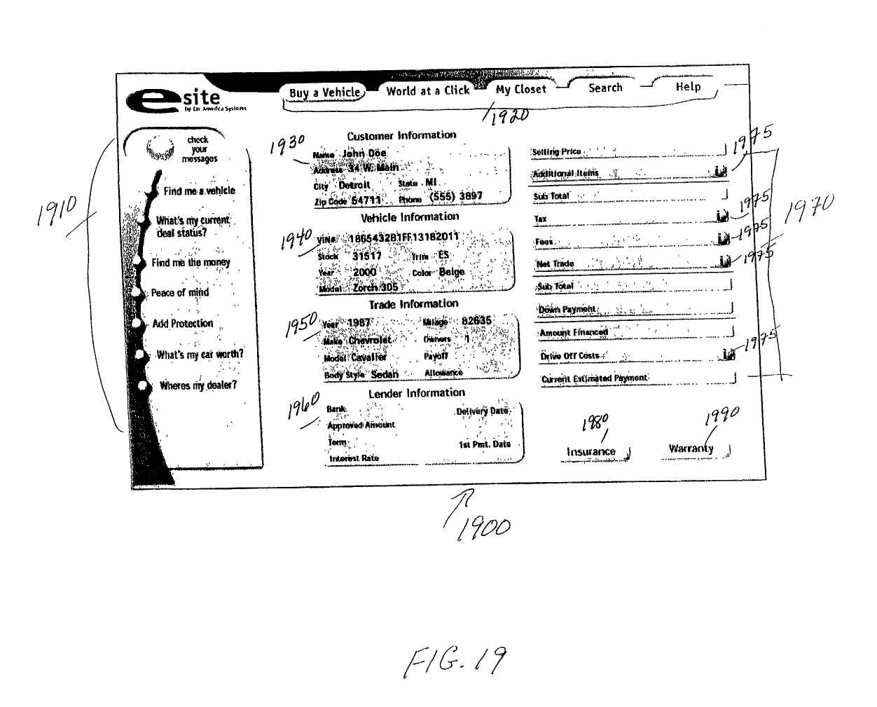

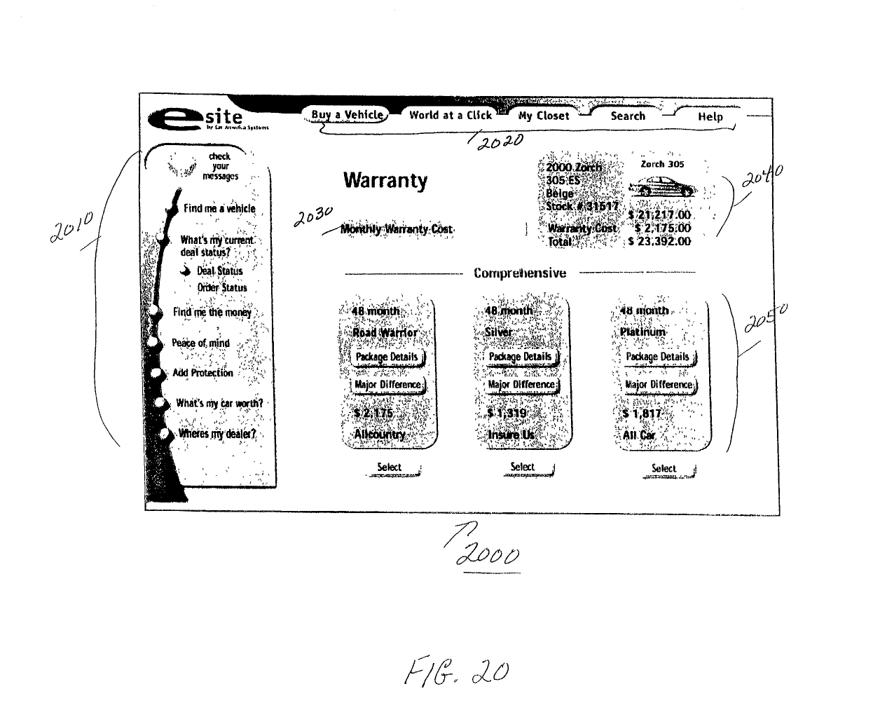

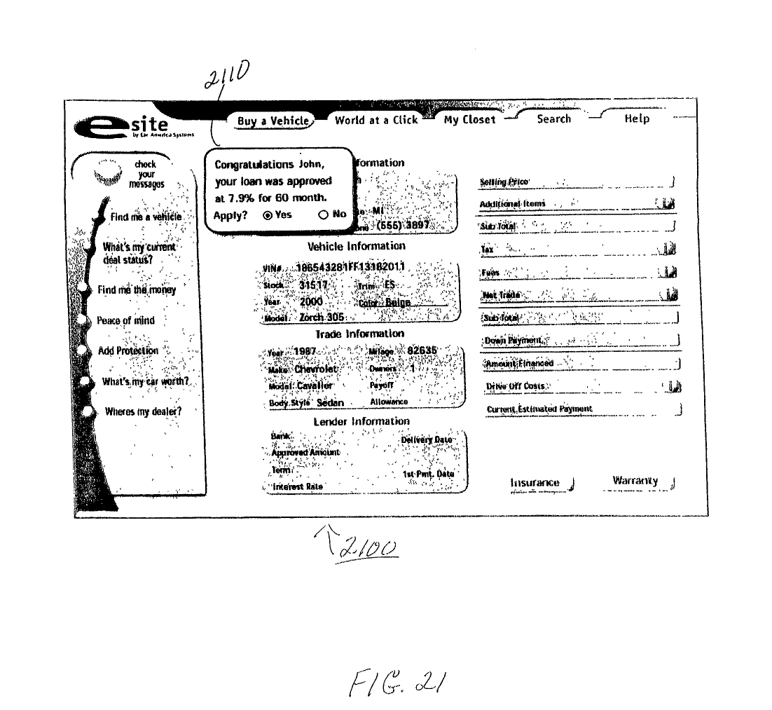

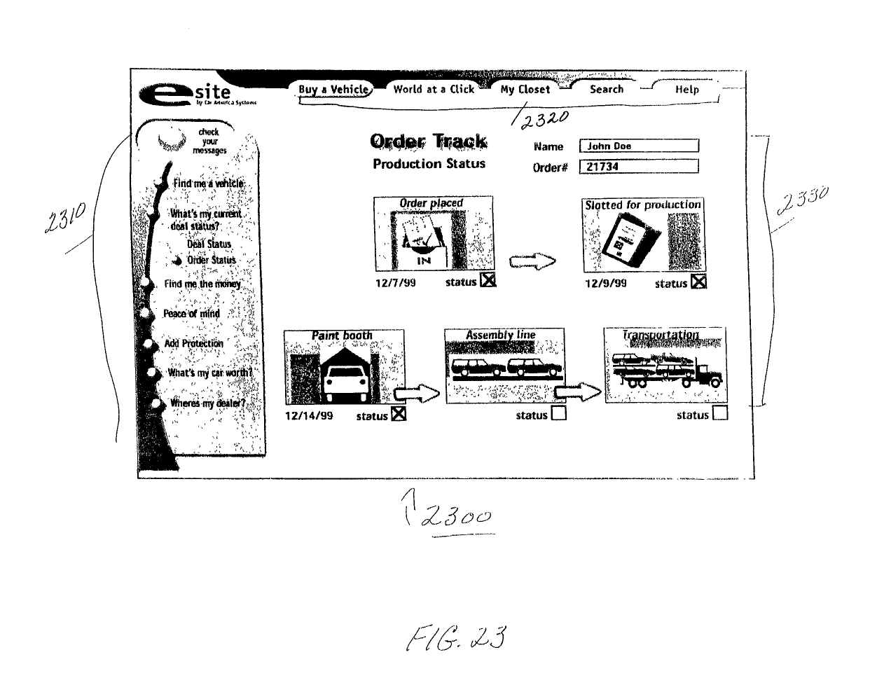

After step 1420, a step 1425 is performed in which notification of the result of the credit application in step 1420 is provided to the consumer. In an exemplary embodiment, a credit notification can include a graphical user interface which provides a message such as “John Doe, your credit has been approved.” The graphical user interface can be similar to the graphical user interface described with reference to FIG. 18. After step 1425, a step 1430 is performed in which the consumer can view what the current deal or purchase of the vehicle includes. In an exemplary embodiment, a graphical user interface is provided which includes information on the purchasing or financing arrangement involving the selected vehicle. One example of the graphical user interface of step 1430 is described below with reference to FIG. 19. In a step 1435, insurance information related to the selected vehicle can be selectively provided. In a step 1440, warranty information regarding the selected vehicle can be selectively provided. An example graphical user interface displaying warranty information is described below with reference to FIG. 20. In a step 1445, a notification is provided that credit is approved. In an exemplary embodiment, notification may be made by a pop-up message as described below with reference to FIG. 21. In an alternative embodiment, notification is provided at the log-in display screen when the consumer logs in (e.g., at a later date). In a step 1450, lender information is added to the information on what the consumers current deal is. After the purchase is completed, a step 1455 is performed in which the consumer can log-in and check on the deal status which allows order tracking and confirmation functions. In an exemplary embodiment, a graphical user interface is provided such as that described below with reference to FIG. 23.

FIG. 15 illustrates an exemplary screen display 1500 of a standard features display function in the exemplary method described with reference to FIG. 14. Screen display 1500 includes a vehicle image display region 1510, a vehicle cost information region 1520, a standard features listing region 1530, functional buttons 1540, and menu buttons 1550. Vehicle image region 1510 provides the consumer a view of an image of the selected vehicle. The consumer has the option to view the vehicle from different positions by selecting a walk-around button 1555. Once the walk-around feature is selected, the consumer uses arrows 1560 to maneuver the image of the vehicle left or right. A filter button 1565 is also provided to filter out certain features of the vehicle. For example, the consumer can use filter 1565 to have a view of the interior of the vehicle.

Vehicle cost information region 1520 provides detailed information on vehicle cost, such as, MSRP, vehicle add-ons, premium packages, and other such options. Standard features listing region 1530 provides a listing of various features provided standard with the selected vehicle. Function buttons 1540 provide various functionalities for the consumer, such as, the ability to review the selection, go to a glossary of terms, or purchase the selected vehicle. Menu buttons 1550 provide a variety of functional choices for the consumer. In one embodiment, the consumer may select one of buttons 1550 to view features, specifications, product comparisons, accessories, towing information, estimated payments, warranty, incoming availability, alternative vehicles, a demonstration, or to print the display information. Advantageously, screen display 1500 allows the consumer to “virtually” visit the dealership and select a vehicle.

FIG. 16 illustrates an exemplary screen display 1600 of a finance estimator function in the exemplary method described with reference to FIG. 14. Screen display 1600 includes a payment information region 1610, an estimated payment calculator region 1620, and menu buttons 1630. Payment information region 1610 includes information on sales price, desired payment, terms, taxes, fees, and other such information. In one embodiment, the consumer is able to easily view the annual percentage rate (APR) and corresponding monthly payments associated with various financing terms. Estimated payment calculator region 1620 provides an image of a calculator which can be used in calculating various financial information. Screen display 1600 allows the consumer to investigate various financing options, purchase vehicles using various financing, compare leasing and buying statistics, and perform a variety of other finance functions. Menu buttons 1630 allow the consumer to request additional information, such as, information regarding cash, retail, balloon, and lease information for financing calculations. Menu buttons 1630 also allow the consumer to compare available financing for various vehicles, apply for credit, identify specials, and print the information provided in screen display 1600.

FIG. 17 illustrates an exemplary screen display 1700 of a credit application function in the exemplary method described with reference to FIG. 14. Screen display 1700 includes a credit selection region 1710 and a keyboard region 1720. Credit selection region 1710 allows the consumer to select credit and financing options, such as, retail, balloon and lease. The consumer may also choose individual credit, joint credit, or individual credit relying on income from different sources. Keyboard region 1720 is provided for the entry of different information to fill out a credit application. In an exemplary embodiment, screen display 1700 is provided on a computer display that allows for touch-screen functionality. As such, the user can touch the screen display and use it as a keyboard for entry of information. In an alternative embodiment, screen display 1700 is displayed on a personal digital assistant (PDA) and keyboard region 1720 facilitates easy entry of information on such a device.

FIG. 18 illustrates an exemplary screen display 1800 of a credit notification function in the exemplary method described with reference to FIG. 14. Screen display 1800 provides an example of notification to the consumer that credit has been approved. Screen display 1800 illustrates notification that credit has been approved upon the logging in to the system. In an alternative embodiment, notification is provided while the consumer is in the system using, for example, some type of message display such as that described with reference to FIG. 21.

FIG. 19 illustrates an exemplary screen display 1900 of a current information log function in the exemplary method described with reference to FIG. 14. Screen display 1900 includes a menu 1910, function tab set 1920, customer information region 1930, vehicle information region 1940, trade information region 1950, lender information region 1960, pricing information region 1970, insurance information region 1980, and a warranty button region 1990. Menu 1910, function tab set 1920, customer information region 1930, vehicle information region 1940, and trade information region 1950 are similar in appearance and functionality to menu 910, function tab set 920, and owner profile region 930 described with reference to FIG. 9.

Lender information region 1960 may or may not include information regarding financing depending on whether the consumer has applied for financing and if that financing has been approved. Pricing information region 1970 includes a variety of information regarding vehicle price. Pricing information region 1970 includes information buttons 1975 which allow the consumer to find out additional information about certain items. Insurance button 1980 allows the user to obtain information on insurance with selected vehicle. Similarly, warranty button 1990 allows the consumer to obtain information on warranties for the selected vehicle. Screen display 1900 advantageously allows the consumer to view customer information, vehicle information, and trading information. The consumer can also link to several references, including tax, fees, trade and drive-off costs. If desired, the consumer can view an insurance screen which provides detailed information on the provider, coverage, exclusions, deductible, and available additional coverage.

FIG. 20 illustrates an exemplary screen display 2000 of a warranty notification function in the exemplary method described with reference to FIG. 14. Screen display 2000 includes a menu 2010, function tab set 2020, a monthly warranty cost region 2030, a vehicle warranty summary region 2040, and warranty options region 2050. Menu 2010, function tab set 2020, and monthly warranty cost region 2030 are similar in function to menu 910, function tab set 920, and owner profile region 930 described with reference to FIG. 9. Vehicle warranty summary region 2040 provides text and images to summarize the vehicle, information and total cost involved with the additional warranty coverage. Warranty options region 2050 provides for information and comparison among various warranty options.

FIG. 21 illustrates an exemplary screen display 2100 of a popup message notification in the exemplary method described with reference to FIG. 14. Screen display 2100 includes a pop-up message 2110 notifying the consumer of the loan status (e.g., approved or declined) of the consumer's credit application. Advantageously, the consumer has the option to accept or decline the loan offer by making a selection in pop-up message 2110.

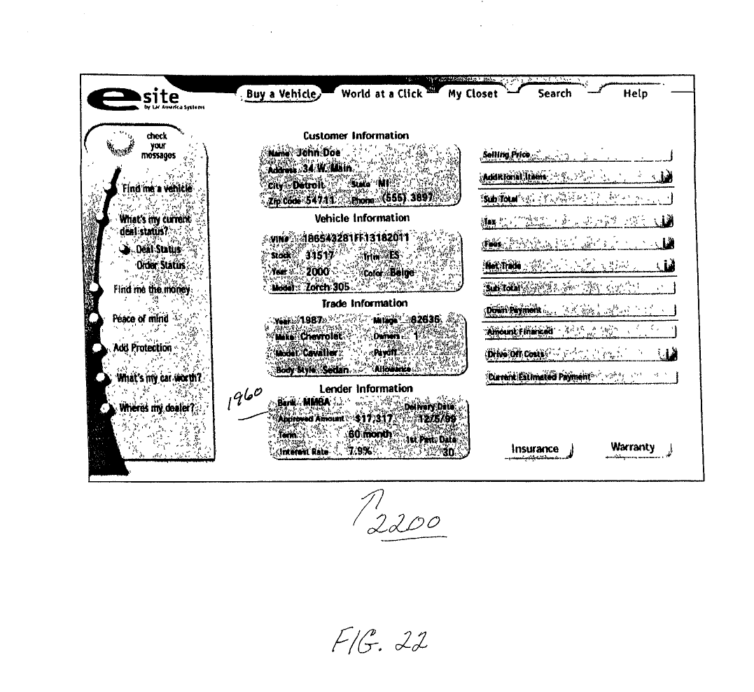

FIG. 22 illustrates an exemplary screen display 2200 of a lender information log function in the exemplary method described with reference to FIG. 14. Screen display 2200 illustrates the addition of lender information to lender information region 1960. Screen display 2200 is identical to screen display 1900 described with reference to FIG. 19 with the exception of the addition of information to lender information region 1960. Information is added to lender information region 1960 when the consumer accepts a loan. This information can include the bank name, amount approved, term, interest rate, and first payment date.

FIG. 23 illustrates an exemplary screen display 2300 of an order tracking function in the exemplary method described with reference to FIG. 14. Screen display 2300 includes a menu 2310, function tab set 2320, and an order tracking display region 2330. Menu 2310 and function tab set 2320 are similar in appearance and functionality to menu 910 and function tab set 920 described with reference to FIG. 9. Order tracking display region 2330 includes the consumer name, the order number, and images depicting the status of the vehicle order corresponding to the consumer and order number. In an exemplary embodiment, order tracking display region 2330 includes images depicting when the order was placed, when the order was slotted for production, when the vehicle was painted, when the vehicle crossed the assembly line, and when the vehicle was transported to a specified location. Advantageously, the consumer can use screen display 1300 to understand the process of manufacturing a vehicle and locate where the specific vehicle of the consumer is in the process.

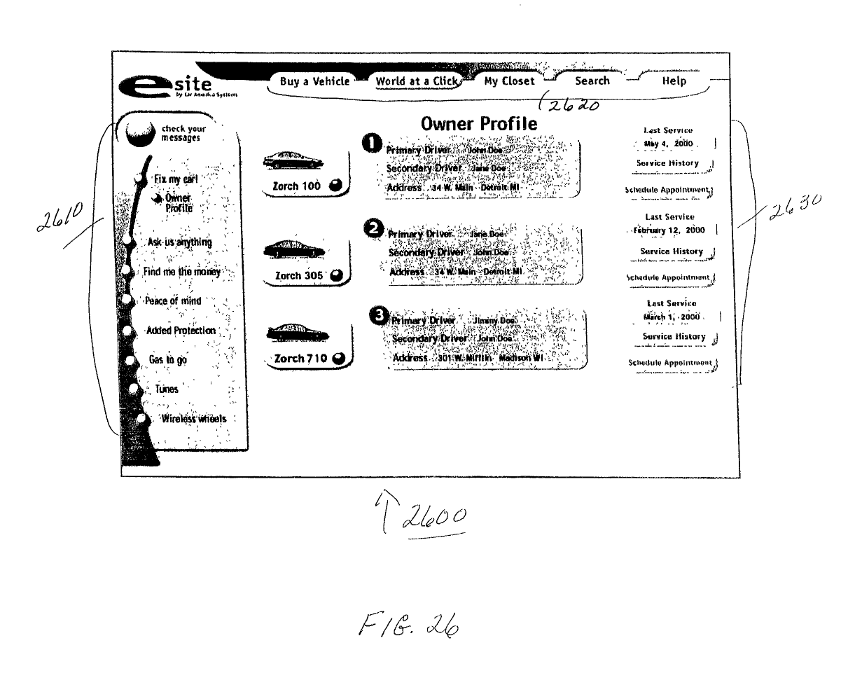

FIG. 24 illustrates a flow diagram 2400 of an exemplary method for facilitating service arrangements between consumers and service providers in system 100. In a step 2410, the consumer logs-in to system 100. After step 2410, a step 2415 is performed in which an owner profile is displayed. In an exemplary embodiment, a screen display is provided to display a profile of the consumer, including, for example, vehicles owned by the consumer, service history, and other relevant information. One example of an owner profile screen display is described with reference to FIG. 26. In a step 2420, the consumer can check the service history for a chosen vehicle. For example, a consumer may identify oil changes, replaced parts, tune-ups, and other such vehicle service functions. In a step 2425, the consumer is able to provide information on the type of service needed for a selected vehicle. If needed, a dealer can be located in a step 2430 using dealer location functions.

When a service is requested in step 2425, system 100 automatically checks the service part availability in a step 2427. If needed, system 100 checks local suppliers for availability of parts needed for service in a step 2429. If further needed, in a step 2432, system 100 orders the part from the manufacturer.

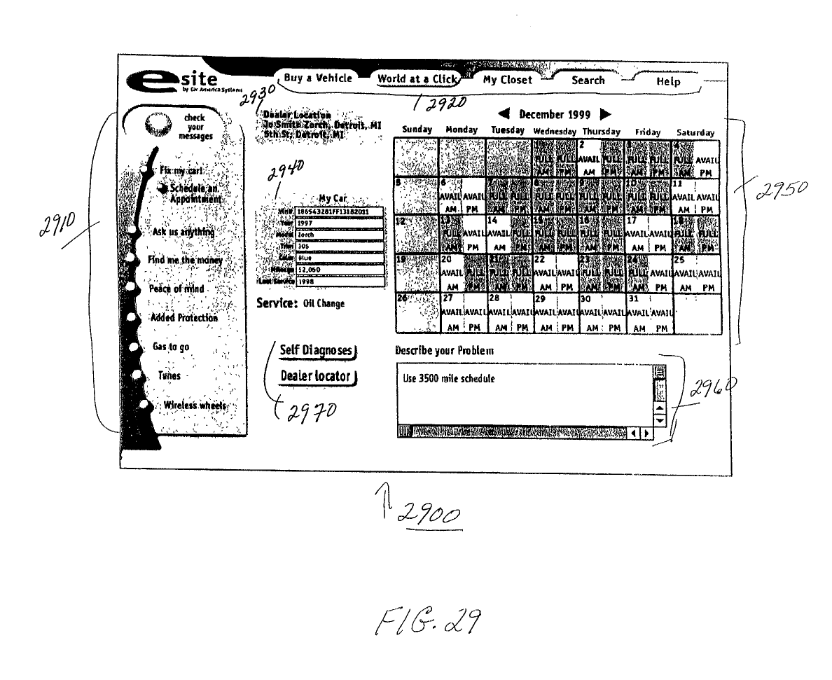

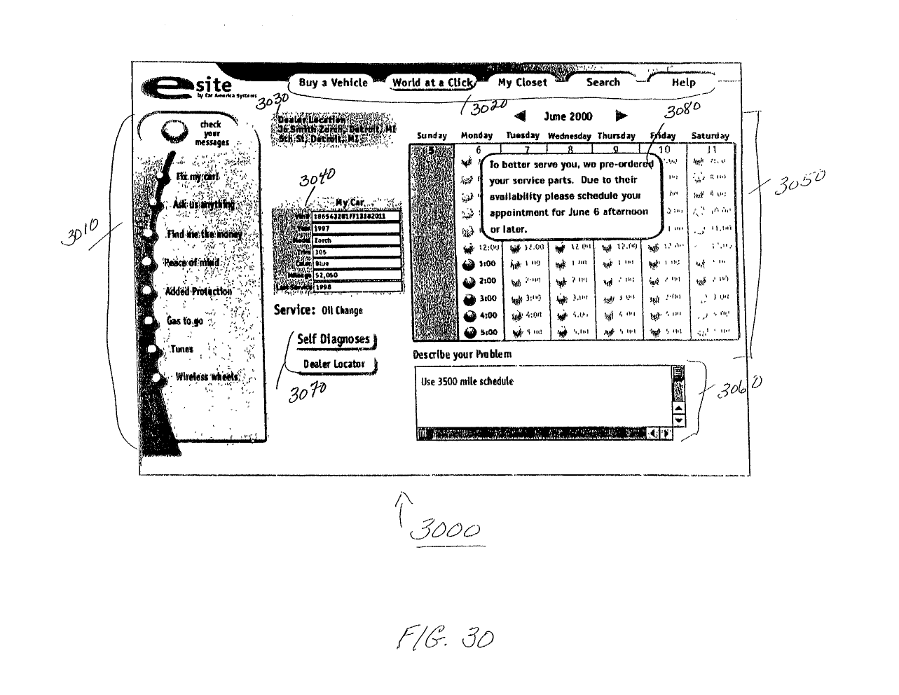

If the service requested in step 2425 requires parts not available, a schedule is provided with a recommendation pop-up message in which the consumer is suggested to schedule an appointment after a date identified as when the needed part will be available. In one embodiment, such a schedule and recommendation message is described with reference to FIG. 30. If a part is not needed to be ordered, a step 2435 is performed in which a screen display is shown to facilitate the scheduling of the service requested in step 2425. One such scheduling screen display is described with reference to FIG. 29.

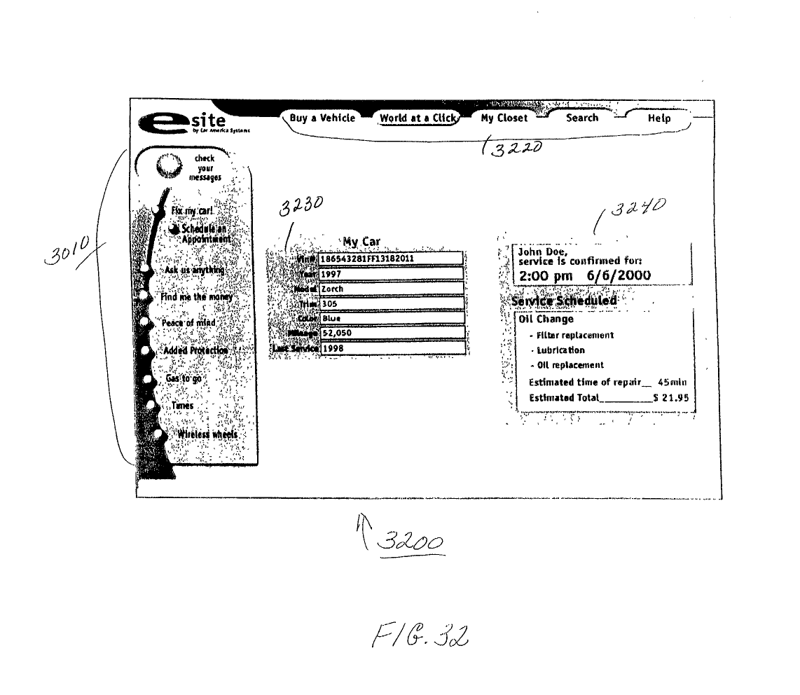

In one embodiment, after the monthly schedule is shown in 2435 or after the schedule with recommendation pop-up messages shown in step 2440, a schedule is shown in a step 2445. Such a schedule is described with reference to FIG. 32. After step 2435, the consumer may select to self-diagnose the vehicle problem in a step 2450. In a step 2455, confirmation of the scheduled service appointment is provided. An exemplary confirmation is described with reference to FIG. 32.

Once the vehicle is ready for pick-up, notification may be provided to the consumer in a variety of different ways. In an exemplary embodiment, the consumer logs in to system 100 in a step 2470. After step 2470, a step 2475 is performed in which notification is provided that the vehicle is ready for pick-up. After step 2475, a step 2480 is performed in which a detailed receipt screen display is provided using a graphical user interface. In an exemplary embodiment, costs of the services provided and a pick-up time or delivery time is suggested or requested. One exemplary detailed receipt screen display is described with reference to FIG. 35. After step 2480, a step 2485 is performed in which payment methods are provided for. In an exemplary embodiment, the consumer may pay on-line or, alternatively, the consumer may pay on receipt of the vehicle. An example payment method screen display is described with reference to the FIG. 36. In a step 2490 the consumer is offered to schedule a pick-up or delivery time. One example pick-up or delivery time screen display is described with reference to FIG. 37.

The method described with reference to flow diagram 2400 provides increased automation, flexibility and information for the consumer and the service provider. Materials may be preordered, appointments may be prearranged, and payment may be made electronically all using the method described with reference to flow diagram 2400. Further, the consumer is provided with an integrated system for selection, purchase, tracking, and servicing of vehicles. As such, there are opportunities to develop brand loyalty and consumer stickiness which has the consumer returning to use system 100 for a variety of functions.

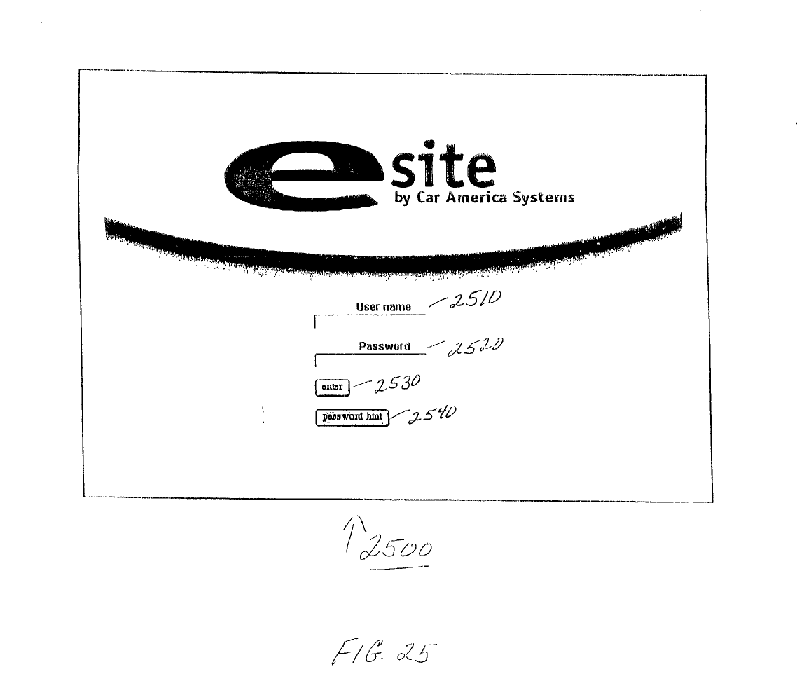

FIG. 25 illustrates an exemplary screen display 2500 of a log-in function in the exemplary method described with reference to FIG. 24. Display 2500 includes a user name field box 2510, a password field box 2520, an enter button 2530, and a password hint button 2540. Display 2500 is substantially identical to screen display 800 described with reference to FIG. 8.

FIG. 26 illustrates an exemplary screen display 2600 of a owner profile function in the exemplary method described with reference to FIG. 24. Screen display 2600 includes a menu 2610, a function tab set 2620, an owner profile information region 2630. Menu 2610 and function tab set 2620 are similar in appearance and functionality to menu 910 and function tab set 920 described with reference to FIG. 9. Owner profile information region 2630 includes images and text detailing information on vehicles owned by a particular owner. For example, a family profile can appear in owner profile information region 2630 with all relevant information for vehicles owned by a family, including information, such as, a photo of the vehicle, the primary vehicle driver, a secondary vehicle driver, an address, last service work, and mileage. From screen display 2600, the consumer has the option to schedule an appointment for service, or find more detailed service history information concerning a specific vehicle.

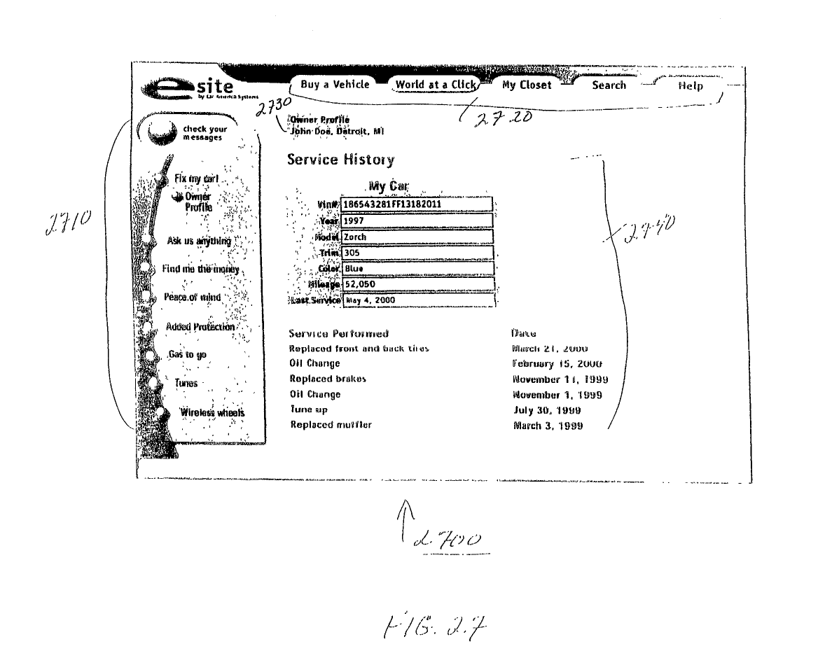

FIG. 27 illustrates an exemplary screen display 2700 of a service history function in the exemplary method described with reference to FIG. 24. Screen display 2700 includes a menu 2710, function tab set 2720, owner profile region 2730, and service history information region 2740. Menu 2710, function tab set 2720, and owner profile region 2730 are similar in appearance and functionality to menu 910, function tab set 920, and owner profile region 930 described with reference to FIG. 9. Service history information region 2740 provides all service performed to a selected vehicle.

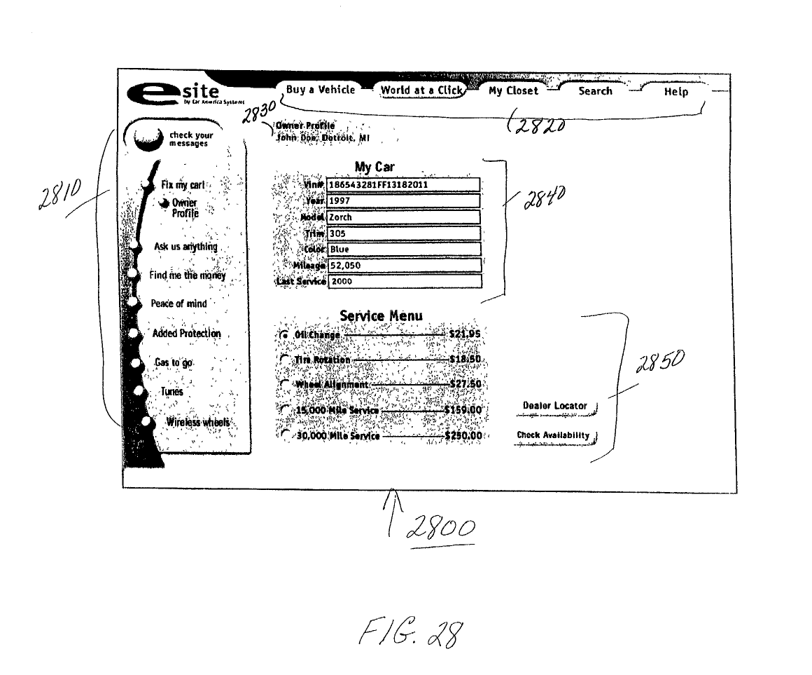

FIG. 28 illustrates an exemplary screen display 2800 of a service type selection function in the exemplary method described with reference to FIG. 24. Screen display 2800 includes a menu 2810, function tab set 2820, owner profile region 2830, vehicle information region 2840, and service selection region 2850. Menu 2810, function tab set 2820, and owner profile region 2830 are similar in function and appearance to menu 2710, function tab set 2720, and owner profile region 2730 described with reference to FIG. 27. Vehicle information region 2840 provides detailed information on a selected vehicle. Service menu information region 2850 allows the consumer to choose which kind of regular vehicle maintenance is desired. Using screen display 2800, a consumer can check availability for regular vehicle maintenance and schedule an appointment.

FIG. 29 illustrates an exemplary screen display 2900 of a scheduling function in the exemplary method described with reference to FIG. 24. Screen display 2900 includes a menu 2910, function tab set 2920, dealer location information region 2930, vehicle information region 2940, calendar region 2950, text input region 2960, and buttons 2970. Menu 2910, function tab set 2920, and dealer location information region 2930 are similar in appearance and functionality to menu 2710, function tab set 2720, and owner profile region 2730 described with reference to FIG. 27. Vehicle information region 2940 is similar in appearance and functionality to vehicle information region 2840 described with reference to FIG. 28. Calendar region 2950 provides a graphical display of availability for servicing of the selected vehicle. In an exemplary embodiment, a full calendar is shown with mornings (AM) and afternoons (PM) divided in each day. Availability for service appointments is identified by the term “AVAIL” and an unshaded section in the calendar. Similarly, where there are no available service appointments a term “FULL” is inserted into the calendar and the corresponding calendar portion is shaded. Text input region 2960 includes a region in which a consumer can describe the problem to be serviced. Buttons 2970 allow the consumer to select a self diagnoses function or a dealer locator function. Screen display 2900 allows the consumer to schedule maintenance requests. If parts are not available, the consumer will see a recommendation pop-up message.

FIG. 30 illustrates an exemplary screen display 3000 of a weekly scheduling function in the exemplary method described with reference to FIG. 24. Screen display 3000 includes a menu 3010, function tab set 3020, dealer location information region 3030, vehicle information region 3040, calendar region 3050, text input region 3060, buttons 3070, and a message display 3080. Menu 3010, function tab set 3020, dealer location information region 3030, vehicle information region 3040, calendar region 3050, text input region 3060, and buttons 3070 are similar in appearance and functionality to menu 2910, function tab set 2920, dealer location information region 2930, vehicle information region 2940, calendar region 2950, text input region 2960, and buttons 2970 described with reference to FIG. 29. For a user whose service part is not directly available through the service department, recommendation pop-up message display 3080 appears over the weekly schedule in calendar display 3050. Message display 3080 informs the user that the part is not available until a specified time. The specified time is based on delivery of the new part. In an exemplary embodiment, local dealers are first checked and then the vehicle manufacturer is checked for part availability, afterwards an order for needed materials is placed and an estimated ship date is provided. The estimated ship date is used for the recommendation provided to the user in message display 3080.

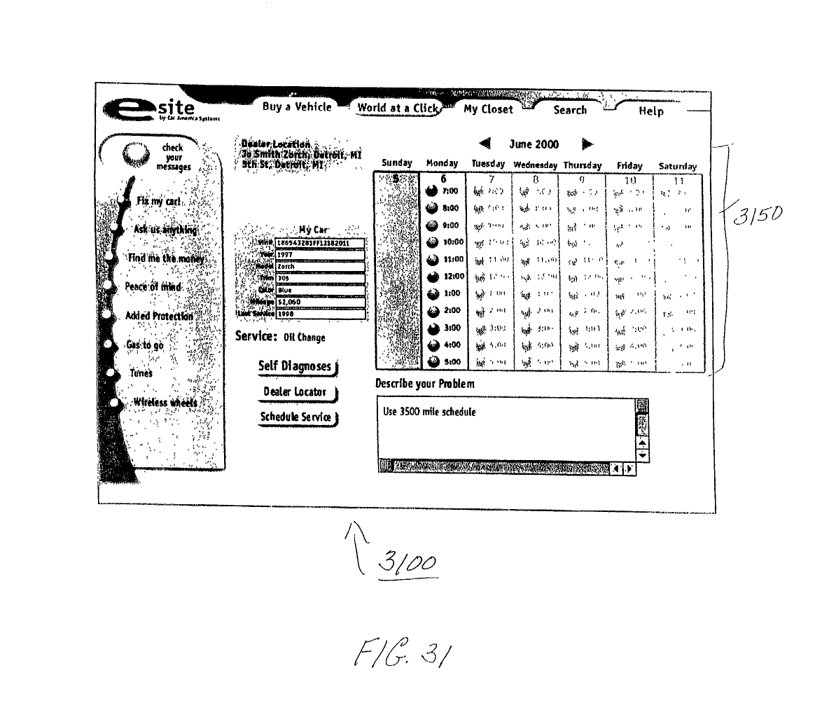

FIG. 31 illustrates an exemplary screen display 3100 of a second weekly scheduling function in the exemplary method described with reference to FIG. 24. Screen display 3100 is similar to screen display 2900 described with reference to FIG. 29 and screen display 3000 described with reference to FIG. 30 with the exception that calendar region 3150 provides more detailed information for service appointment scheduling.

FIG. 32 illustrates an exemplary screen display 3200 of a confirmation function in the exemplary method described with reference to FIG. 24. Screen display 3200 includes a menu 3210, function tab set 3220, vehicle information region 3230, and service information region 3240. Menu 3210, function tab set 3220, and vehicle information region 3230 are similar in appearance and functionality to menus, function tab sets, and vehicle information regions illustrated in previous screen displays. Service information region 3240 provides information related to the service scheduled for the consumer.

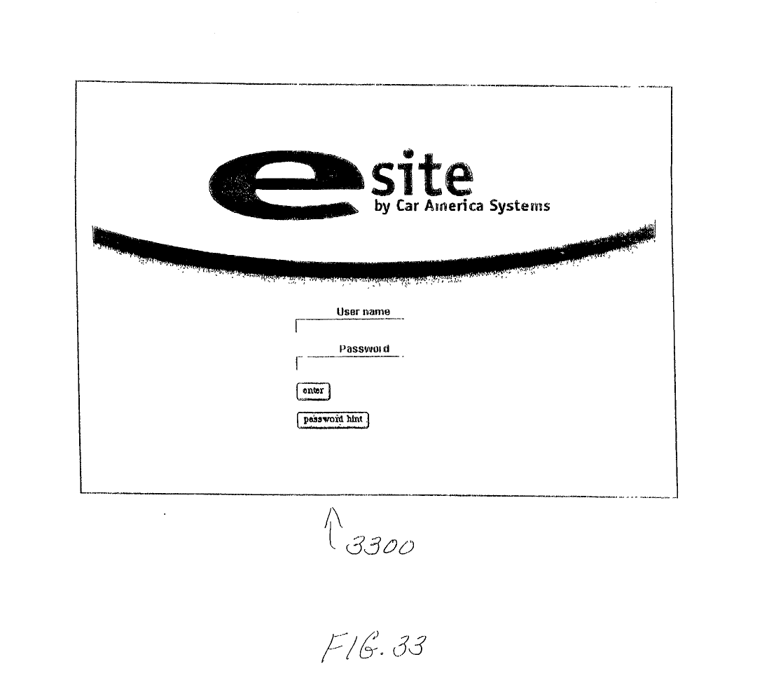

FIG. 33 illustrates an exemplary screen display 3300 of a log in for pick up function in the exemplary method described with reference to FIG. 24. Screen display 3300 is a log-in screen substantially similar in appearance and functionality to screen display 800 described with reference to FIG. 8. The consumer may log-in to see if there are any messages, such as, the completion of service on a vehicle.

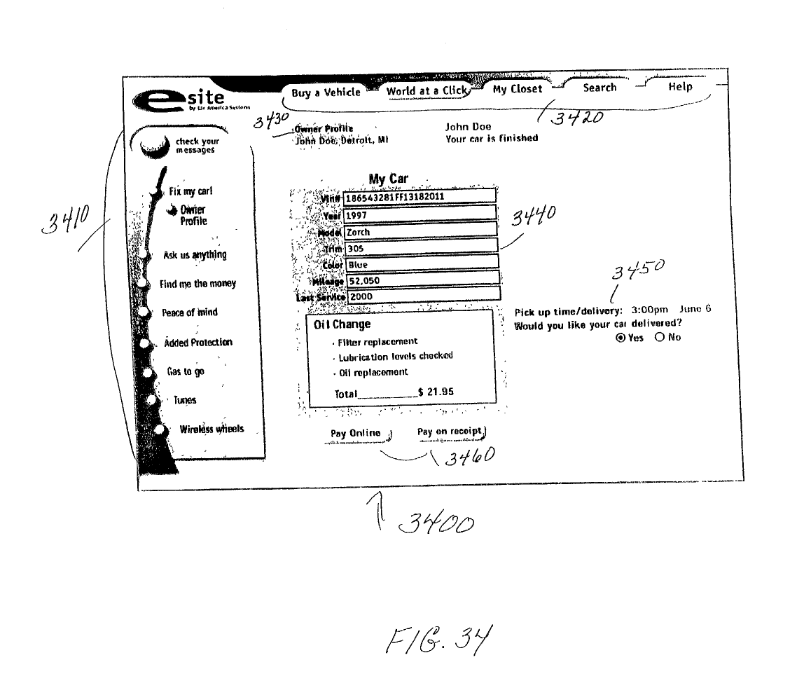

FIG. 34 illustrates an exemplary screen display 3400 of a details receipt function in the exemplary method described with reference to FIG. 24. Screen display 3400 includes a menu 3410, function tab set 3420, owner profile region 3430, vehicle service information region 3440, pick-up confirmation region 3450, and buttons 3460. Menu 3410, function tab set 3420, and owner profile region 3430 are substantially similar in appearance and functionality to menu 910, function tab set 920, and owner profile region 930 described with reference to FIG. 9. Vehicle service information region 3440 provides information on a selected vehicle and the services performed and total cost. Pick-up information region 3450 provides a proposed pick-up time and delivery and a selection choice for the consumer to pick whether or not to have the car delivered. Buttons 3460 allow the consumer to chose whether to pay online or pay on receipt of the serviced vehicle. Advantageously, system 100 allows the consumer a convenient way to pay for repairs, such as, over the Internet using a credit card.

Advantageously, one embodiment of system 100 allows consumers to review and compare vehicle information for one or more original equipment manufactures. One embodiment of system 100 also allows for customer profiling and predication routines to provide targeted information and services related to vehicles and commercial transactions. As such, tailored offerings are possible. System 100 also has the advantage of enabling the communication among dealer, manufacturer, and consumer. Such communication provides for increased information flow to improve the process of manufacturing, distributing, and providing consumers with vehicles.

While the embodiments illustrated in the FIGURES and described above are presently preferred, it should be understood that these embodiments are offered by way of example only. Other embodiments may include various input devices and communication means for facilitating communication of customer and product information. Further, while exemplary embodiments are illustrated using automobiles, any vehicle with identification can be included in system 100. The invention is not limited to a particular embodiment, but extends to various modifications, combinations, and permutations that nevertheless fall within the scope and spirit of the appended claims.

What is claimed is:

1. A system for electronically gathering data about a potential customer of a new or used product, wherein a portion of the consideration the customer will rely on to purchase or lease the new product is a used product, the system comprising:
a data processing module accessible by a manufacturer of the new product;
a location for displaying samples of the new product; and
an input device located at the location and coupled to the data processing module, the input device being useable to convey customer data representative of characteristics of the customer to the data processing module, wherein the customer data is stored in the data processing module and is accessible by the manufacturer.

2. The system of claim 1, wherein the input device includes a display device and a keyboard.

3. The system of claim 1, wherein the input device is a handheld input device for inputting data descriptive of the customers used product.

4. The system of claim 3, wherein the input device communicates with a second data processing system using wireless data transmission.

5. The system of claim 4, wherein the used product is a vehicle having an identification.

6. The system of claim 5, wherein the identification is a vehicle identification number.

7. The system of claim 5, wherein the input device includes a user interface which prompts the user with predetermined questions based upon the identification.

8. The system of claim 3, wherein the input device includes a digital optical device for generating images of the used product.

9. The system of claim 3, wherein the input device includes a voice input circuit for generating data representative of the voice of the user.

10. The system of claim 3, wherein the input device includes a vehicle identification number (VIN) decoder.

11. A method of electronically gathering data about a potential customer of a new or used product, wherein a portion of the consideration the customer will rely on to purchase or lease the new product is a used product, the method comprising:
processing data accessible by a manufacturer of the new product;
displaying samples of the new product; and
conveying customer data representative of characteristics of the customer to a data processing module, wherein the customer data is stored in the data processing module and is accessible by the manufacturer.

12. The method of claim 11, wherein the step of displaying samples of the new product comprises communicating information to a computer interface.

13. The method of claim 12, wherein the computer interface comprises an Internet browser.

14. The method of claim 11, further comprising communicating data associated with products of interest to the potential customer.

15. The method of claim 11, further comprising communicating modifications of customer data to the data processing module.

16. A system in which data is electronically gathered about a potential customer of a new product, wherein a portion of the consideration the customer will rely on to purchase or lease the new product is a used product, the system comprising:
means for processing data accessible by a manufacturer of the new product;
means for displaying samples of the new product; and
means for conveying customer data representative of characteristics of the customer to a data processing module, wherein the customer data is stored in the data processing module and is accessible by the manufacturer.

17. The system of claim 16, wherein the means for displaying samples of the new product comprises means for communicating information to a computer interface.

18. The system of claim 16, further comprising means for communicating data associated with vehicles of interest to the potential customer.

19. The system of claim 16, further comprising means for conveying a grading for a used product to the data processing module.

20. A system for electronically gathering data about a potential customer of a vehicle, the system comprising:
a first location at which the vehicle is displayed, reviewed, delivered, or sold;
a data processing module for storing customer data in association with a customer identification;
a first data input module located at the first location for communicating data about the customer to the data processing module, wherein the data includes at least data about one or more products of interest to the customer; and
a second data input module located at a location geographically separated from the first location, the second data input module being configured to communicate with the data processing module via a network to permit access to and modification of the customer data by the customer identified by the customer identification.

21. The system of claim 20, wherein the customer data is stored in the data processing module as a record in a data base in relationship to the customer identification.

22. The system of claim 21, wherein the data input modules include graphical user interfaces.

23. The system of claim 22, wherein at least a portion of the network is the Internet.

24. The system of claim 23, wherein the record further includes data about a product under the control of the customer.

25. The system of claim 24, wherein the record further includes financial data relating to the customer.

26. The system of claim 23, wherein the vehicle is a car, truck, motorcycle, boat, plane, scooter, ATV, water device, off-road vehicle, construction equipment, or farm equipment.

27. The system of claim 23, further comprising a communications module which provides a customer using the second data input module with picture, video or alphanumeric data about a vehicle selected by the customer.

28. The system of claim 27, wherein the picture, video or a alphanumeric data is stored by the data processing module.

29. The system of claim 24, wherein the first data input module is a wireless handheld device for communicating data about the vehicle under control of the customer.

30. The system of claim 24, wherein the data about the vehicle includes the vehicle identification number, the number of miles or hours or other measurement of usage of the vehicle, and data about the condition of the vehicle.

31. A method for electronically gathering data about a potential customer of a vehicle, the method comprising:
displaying, reviewing, delivering, or selling a vehicle;
storing customer data in association with a customer identification;
communicating data about the customer to a data processing module,
wherein the data includes at least data about one or more products of interest to the customer; and
communicating with the data processing module via a network to permit access to and modification of the customer data by the customer identified by the customer identification.

32. The method of claim 31, further comprising communicating data about a used vehicle, the data being used to determine a value of the used automobile.

33. The method of claim 31, further comprising engaging a sales and appraisal tool.

34. The method of claim 33, wherein the sales and appraisal tool is engaged by computer software involving the Internet.

35. The method of claim 33, wherein the sales and appraisal tool is engaged at a kiosk located at an automobile distribution location.

36. The method of claim 31, further comprising selectively engaging commercial transactions involving the customer, the commercial transactions comprising purchase, lease, financing, and trade-in transactions.

37. The method of claim 31, wherein the one or more automobiles of interest comprise automobiles manufactured by a plurality of original equipment manufacturers.

38. A system which electronically gathers data about a potential customer of a vehicle, the system comprising:
means for displaying, reviewing, delivering, or selling a vehicle;
means for storing customer data in association with a customer identification with a data processing module;
means for communicating data about the customer to the data processing module, wherein the data includes at least data about one or more automobiles of interest to the customer; and
means for communicating with the data processing module via a network to permit access to and modification of the customer data by the customer identified by the customer identification.

39. The system of claim 38, further comprising means for communicating data about a used automobile, the data being used to determine a value of the used automobile.

40. The system of claim 38, further comprising means for engaging a sales and appraisal tool.

41. The system of claim 40, wherein the sales and appraisal tool is engaged by a computer software means for communicating using the Internet.

42. The system of claim 40, wherein the sales and appraisal tool is engaged at an automobile distribution location.

43. The system of claim 38, further comprising means for selectively engaging commercial transactions involving the customer, the commercial transactions comprising purchase, lease, financing, and trade-in transactions.

44. The system of claim 38, wherein the one or more automobiles of interest comprise automobiles manufactured by a plurality of original equipment manufacturers.

45. A method of doing business in which a central firm provides technology and information services to at least one recipient comprising at least one of an original equipment manufacturer (OEM) and an OEM dealer/distributor, the method comprising:
receiving at the central firm an expense payment from a recipient of the technology and information services;
communicating information among and between a customer and the recipient; and thereby
facilitating commercial transactions with the customer.

46. The method of claim 45 wherein the product is a vehicle.

47. The method of claim 46 further comprising providing the at least one dealer and the at least one OEM with a return on investment for the product purchases by the customer.

48. The method of claim 45, wherein the step of facilitating commercial transactions comprises engaging the sales process.

49. The method of claim 45, wherein the step of facilitating commercial transactions comprises initiating a financing process.

50. The method of claim 45, wherein the step of communicating information comprises conveying customer data representative of characteristics of the customer to the recipient.

51. The method of claim 45, wherein the recipient comprises a plurality of original equipment manufacturers.
